(19) United States
(12) Patent Application Publication
(10) Pub. No.: US 2023/0039298 A1
(43) Pub. Date: Feb. 9, 2023

(54) LINEAR-MOTOR-DRIVEN TRACKED VEHICLE

(71) Applicant: MagneCat UG, Bayreuth (DE)

(72) Inventor: Achim Keppner, Bayreuth (DE)

(21) Appl. No.: 17/793,023

(22) PCT Filed: Jan. 15, 2021
(86) PCT No.: PCT/EP2021/050803

§ 371 Date: Jul. 14, 2022

(30) Foreign Application Priority Data
Jan. 17, 2020 (DE) 10 2020 101 114.8

(51) Int. Cl. B66B 11/04; B66B 9/00; H02K 41/03

(52) U.S. Cl. CPC B66B 11/0407; B66B 9/003; H02K 41/031

(57) ABSTRACT

A tracked vehicle encompassing: a load subassembly; a drive track that is retained movably on the load subassembly in order to execute a motion along a circulation path of the drive track;

a linear motor, a stator of the linear motor being arranged in stationary fashion with respect to the load subassembly, and a rotor of the linear motor being arranged for motion together with the drive track, and/or the rotor being embodied in the drive track; the rotor having permanent magnets that are arranged in the drive track and are embodied for motion together with the drive track.

This Application claims priority in PCT application PCT/EP2021/050803 filed on Jan. 15, 2021, which claims priority in German Patent Application DE 10 2020 101 114.8 filed on Jan. 17, 2020, which are incorporated by reference herein.

The present invention relates to a tracked vehicle, and to a vehicle system having a racked vehicle and a travel path arrangement.

### BACKGROUND OF THE INVENTION

Floor-based tracked vehicles that travel on horizontal or slightly inclined surfaces, for example in the form of tracked excavators, are known. UA 65559 C2 discloses a tracked vehicle that is embodied to travel on a ferromagnetic surface. In the known tracked vehicle, a linear motor drives a drive track. Provided in the drive track are ferromagnetic inserts in which a magnetic field, which produces an attractive magnetic force between the drive track and the ferromagnetic surface, is induced by vehicle-frame-mounted permanent magnets. The tracked vehicle furthermore encompasses coils for generating a magnetic field by means of which a circulating motion is imparted to the ferromagnetic inserts and thus to the drive track. UA 65559 C2 describes the fact that the speed of the linear motor is regulated by way of the current intensity of the current flowing through the coils. According to UA 65559 C2, because of the above-described magnetic attractive force between the drive track and the ferromagnetic surface, the known tracked vehicle is intended to be displaceable even in a vertical direction along a correspondingly vertically oriented ferromagnetic surface.

A disadvantage of the tracked vehicle of UA 65559 C2 is that only the ferromagnetic inserts currently present between the permanent magnets and the substrate being traveled on make a contribution to the adhesion of the tracked vehicle on the ferromagnetic surface, with the result that a change from horizontal to vertical, in a small space, in the orientation of the ferromagnetic surface being traveled on cannot be negotiated by the tracked vehicle of UA 65559 C2.

Furthermore, the drive track can move away from the permanent magnets as a result of surface irregularities in the surface that is being traveled on during operation and that is therefore contacted by the drive track; this can result in an enlargement of the air gap between the permanent magnets and the ferromagnetic inserts, and consequently in a weakening of the magnetic field in the ferromagnetic inserts which produces the attractive magnetic force. In a vertical travel mode, this can cause the tracked vehicle to drop off.

### SUMMARY OF THE INVENTION

The object of the present invention is therefore to furnish a reliable and simple tracked vehicle for traveling on ferromagnetic surfaces, as well as a vehicle system made up of a tracked vehicle and a corresponding travel path arrangement.

This object is achieved according to the present invention by a tracked vehicle according to Claim 1, a vehicle system according to Claim 11, and a use thereof according to Claim 21. Preferred embodiments of the invention are described in the dependent claims.

A tracked vehicle according to the present invention encompasses: a load subassembly; a drive track that is retained movably on the load subassembly in order to execute a motion along a circulation path of the drive track; a linear motor, a stator of the linear motor being arranged in stationary fashion with respect to the load subassembly, and a rotor (also called runner or secondary) of the linear motor being arranged for motion together with the drive track, and/or the rotor being embodied in the drive track; and the rotor comprising permanent magnets that are arranged in the drive track and are embodied for motion together with the drive track.

The provision of permanent magnets in the rotor for motion together with the drive track simplifies the configuration of the linear motor as compared with UA 65559 C2, since load-subassembly-mounted permanent magnets can be omitted. The permanent magnets of the rotor of the tracked vehicle according to the present invention have a dual function: as part of the linear motor, and as elements furnishing an attractive force between the tracked vehicle and a magnetizable substrate. Because the attractive magnetic force between the permanent magnets and a magnetizable substrate, which is an embodiment of a travel path arrangement having a magnetizable carrying arrangement, does not depend on the distance (which may change locally during dynamic operation) between the drive track and the stator, a substantially constant attractive force between the tracked vehicle and a magnetizable substrate is reliably furnished by the tracked vehicle.

In a particularly preferred embodiment, there exists between the stator and the rotor of a linear motor an air gap that, upon energization of the stator, is held open during operation of the tracked vehicle as intended (analogously to a “maglev” process („Maglev“ being the abbreviation for “magnetic levitation”)) by the interaction of the magnetic fields of the stator and of the rotor, with no assistance from further support elements such as rollers, plain bearings, or the like, as a result of the dimensioning of the magnetic fields in the rotor and in the stator.

The term “travel path arrangement” will be used hereinafter when referring to an arrangement, traveled on or capable of being traveled on by the tracked vehicle, on which an attractive force, produced by a magnetic interaction with the permanent magnets of the rotor, is exerted by the drive track. The travel path arrangement can comprise, for example, a magnetizable plate, for instance encompassing or being made of iron or magnetizable steel, on which the tracked vehicle travels. Although non-magnetizable material can be provided between a carrying arrangement of the substrate or travel path arrangement, which comprises the directly magnetizable material of the travel path arrangement and thus ensures the magnetic interaction with the drive track, and the track supporting surface of the substrate or travel path arrangement which is contacted by the drive track as the travel path arrangement is traveled on by the tracked vehicle along a motion path, the track supporting surface is preferably, because of the greater attractive force achievable for an otherwise identical configuration, a surface of the carrying arrangement.

It is preferred that permanent-magnet arrangements, having a polarization direction that is uniform but is alternatingly opposite over several or all permanent-magnet arrangements, be arranged one behind another in the drive track along the circulation path of the drive track. This allows the magnetic field that can be constituted by the stator to be utilized optimally in order to advance the tracked vehicle. Such an arrangement of permanent magnets can be a Halbach arrangement (also called a “Halbach array”), in which at least one return flow magnet, having a differing polarization that is usually orthogonal relative to the polarization of the permanent-magnet arrangements, is arranged between two permanent-magnet arrangements having alternating polarization. Further permanent magnets of the rotor can be arranged in the drive track between permanent-magnet arrangements arranged one behind another. In order to achieve a symmetrical magnetic field for interaction with the travel path arrangement and with the stator, however, it is preferred that permanent-magnet arrangements that are directly successive to one another along the circulation path and are arranged in the drive track be arranged with a polarization direction that is uniform within the same permanent-magnet arrangement but is alternatingly opposite over several or all permanent-magnet arrangements. The permanent-magnet arrangements of the rotor, arranged in the drive track and arranged and/or embodied for motion together with the drive track, encompass or are constituted by the permanent-magnet arrangements arranged one behind another and/or immediately successively in the drive track along the circulation path.

A driving track described in the previous paragraph can be configured particularly compact, the same applies for chain links, which can be comprised by the drive track. By this means the drive system of the tracked vehicle can be configured in a compact manner.

A permanent-magnet arrangement can comprise exactly one or a plurality of permanent magnets. Especially in a context of chain links that are short along the circulation path, it can be advantageous in terms of achieving sufficient linearmotor advance force to use permanent-magnet arrangements each having a plurality of permanent magnets arranged with identical polarity, different permanent-magnet arrangements succeeding one another along the circulation path being arranged with alternating polarizations. If a permanent-magnet arrangement encompasses more than one permanent magnet, the permanent magnets of a permanent-magnet arrangement are preferably arranged along the circulation path one behind another and directly successively. If permanent-magnet arrangements each having several permanent magnets are provided, it is preferred, in order to achieve a rotor magnetic field that is as uniform as possible along the circulation path, for all the permanent-magnet arrangements having polarization directions alternating relative to one another to have an identical number of permanent magnets.

In particular in case of formation of a permanent magnet arrangement out of multiple permanent magnets, the permanent magnets can comprise or be form by bar-shaped or/and needle-shaped permanent magnets in order to increase robustness of the permanent men arrangement against local damage. Thus, the single permanent magnet out of the multiple permanent magnets forming a permanent magnet arrangement shows preferably along its polarization direction a larger dimension than orthogonal to this dimension.

In order to simplify the description of the invention, preferred permanent-magnet arrangements that each comprise only exactly one permanent magnet will be assumed hereinafter. Thus, the statements previously made with respect to the permanent magnet arrangement apply also to the permanent magnet mentioned in the following instead of the permanent magnet arrangement.

The polarization direction of a permanent magnet (e.g. a direction that points from the north pole to the south pole of the permanent magnet) preferably proceeds (extends) transversely or orthogonally to the circulation path and/or preferably faces from an internal region, enclosed by the drive track, of the drive track into an external region, located outside the drive track, of the drive track, or vice versa.

The tracked vehicle can encompass a position detection device in order to determine a circulation position of the drive track along the circulation path of the drive track. The position detection device can be arranged between stator portions and/or can be configured to determine a relative position of permanent magnets in the drive track relative to the stator.

The stator comprises in particular, along at least a portion of the circulation path, stator windings arranged one behind another for generating a magnetic field upon energization of the stator windings, the tracked vehicle comprising a power converter which is electrically conductively connected to the stator windings and by way of which, in particular, the stator windings are energizable. It is thereby possible, by energizing the stator windings, to constitute a migrating alternating magnetic field in order to produce a drive force driving the drive track, said drive force engaging on the permanent magnets of the rotor.

An alternating voltage, preferably a multi-phase, in particular three-phase, alternating voltage, can be furnished to the tracked vehicle in order to supply the power converter, so that the power converter is preferably embodied as a frequency converter having a plurality of input phases, in particular three input phases, and/or having a plurality of output phases, in particular three output phases. Each of the output phases can output an alternating voltage whose amplitude and/or frequency and/or phase can be regulated or controlled by the power converter. This regulation or control can be carried out by pulse width modulation (PWM) using a PWM apparatus. A power converter of this kind can be a frequency converter that can encompass a rectifier on the input side, an inverter on the output side, and a DC voltage link circuit connected electrically between the rectifier and the inverter, the DC voltage link circuit being supplied with electricity by the rectifier, and the DC voltage circuit supplying electricity to the inverter. The PWM apparatus can be part of the power converter.

The stator windings of each individual one of the linear motors of the tracked vehicle can be electrically conductively connected to a separate power converter associated with the respective linear motor, in order to energize those stator windings. The stator windings of a plurality of, or of all, the linear motors of the tracked vehicle can also be electrically conductively connected to a common power converter in order to energize those stator windings.

The tracked vehicle can be configured to be supplied from outside, for example via a building-side rectifier, with a DC voltage for powering the at least one power converter carried on the tracked vehicle in order to energize the stator windings with electrical energy. The power converter used in this instance can encompass a DC voltage link circuit supplied directly with electricity via that DC voltage, and an inverter supplied with electricity from the DC link circuit and electrically connected to it, but no rectifier for supplying electricity to the DC voltage link circuit; this results in an advantageous reduction in the weight of the tracked vehicle.

In order to ensure uninterrupted operation of the tracked vehicle even in the event of an interruption in building-mounted electricity delivery, the tracked vehicle can encompass an energy reservoir for supplying the power converter with electrical energy, the energy reservoir preferably being embodied separately from the power converter. In particular, this energy reservoir thus performs no function in terms of adaptation by the power converter of an output voltage, an output current, an output frequency, and an output phase of the power converter.

The tracked vehicle can be supplied with electrical energy in particularly simple and reliable fashion if it encompasses a current collector for supplying the power converter with electrical energy.

The “load subassembly” is understood as a subassembly that carries a load in the tracked vehicle. The load encompasses at least the dead weight of the tracked vehicle, preferably additionally a loadable useful load. The load subassembly can encompass a frame of the tracked vehicle on which, for example, the stator and/or a motion guide of the drive track is/are arranged and/or fastened. Components secured to the frame of the load subassembly are also components of the load subassembly. The load subassembly can encompass a load receiving space, in particular a cab for transporting people and/or loads, and/or an interlocking apparatus, for example for constituting a releasable secure connection between the load subassembly and a container for people and/or loads.

In view of the configuration according to the invention of the tracked vehicle, a load subassembly can only be understood as a subassembly that carries a load in the tracked vehicle, such that the load subassembly provides the transmission at least of the dead weight of the tracked vehicle via the drive track onto the track supporting surface of the substrate or provides the transmission onto the travel pass arrangement, the drive track is in contact with.

In the present application the support direction is to be understood as a direction extending perpendicular to the track supporting surface of the substrate or of the travel pass arrangement. This support direction extends preferably parallel to the yaw axis of the tracked vehicle. The tracked vehicle can comprise a retaining platform rotatable in a plane oblique to, preferably perpendicular to, the support direction, or can comprise a plurality of such retaining platforms, each rotatable in a respective plane oblique to, preferably perpendicular to, the support direction. On a retaining platform, on a plurality of the retaining platforms or on all of the retaining platforms a drive track or a plurality of drive tracks can be provided. A retaining platform, a plurality of the retaining platforms or all of the retaining platforms can be connected by means of screws or/and rivets or/and welding seams or/and an adhesive with an assigned frame or with a plurality of assigned frames. Each of the frames can carry the stator of a linear motor, which can drive a drive track, which drive track preferably circles the frame. A load subassembly can comprise or be formed by such a frame and/or can comprise or be formed by a plurality of such frames, which are essentially rigidly interconnected. Furthermore, the load subassembly can comprise the above mentioned retaining platform, with which retaining platform the at least such frame is connected for common movement.

In order to allow a transition from horizontal to vertical portions of a travel path arrangement to be negotiated when the tracked vehicle is traveling under its own drive power, the drive track preferably circulates around the load subassembly along the circulation path. In order to allow abutment of the drive track against a substrate to be achieved at any desired point on the drive track with minimum external dimensions for the tracked vehicle, the entire circulation path can proceed along an outer contour of the tracked vehicle.

The drive track can encompass a plurality of chain links connected pivotably to one another. Each chain link is preferably embodied to be rigid. Additionally or alternatively, one permanent magnet of the rotor is arranged in one of, a plurality of, or each of the chain links. A buffer unit, for example a rubber block, can be arranged on a supporting surface of the drive track facing toward the surface to be traveled on, in particular a track supporting surface of the travel path arrangement, in order to decrease rolling noise and/or to damp rolling impacts.

A chain link, a plurality of or all of the chain links can be configured essentially in a plate-shaped manner. Preferably at least one of, a plurality of or all of the permanent magnets of the rotor, that are arranged in the drive track and are configured for common motion with the drive track, extend in a respective one essentially plate-shaped configured chain link, which is associated with the permanent magnet or with the plurality of permanent magnets. One of, a plurality of or all of the permanent magnets of the rotor arranged in the drive track, that are arranged in the drive track and are configured for motion together with the drive track can be configured essentially in a plate-shaped manner.

In a tracked vehicle according to the invention the drive force is transmitted preferably without any pulling force to the chain links, hence in particular without a transmission of any pulling force between directly adjacent and directly connected chain links. Preferably no tilting moments are transmitted to the chain links during transmission of the driving force.

Circulation of a drive track upon travel on a travel path arrangement is accompanied by release processes in which a portion of the drive track releases from the travel path arrangement, and by contacting processes in which a portion of the drive track comes into contact with the travel path arrangement. Because of the attractive force between the permanent magnets of the rotor and the travel path arrangement, the releasing processes and contacting processes are often accompanied by considerable noise emissions and by jerking and vibrations. The noise emissions and/or jerking and/or vibrations can be attenuated if the drive track encompasses a neutralization strand in which an activatable neutralization magnet arrangement of the tracked vehicle is arranged; the neutralization magnet arrangement being configured to constitute, at the neutralization strand, a magnetic field that quantitatively weakens or in fact neutralizes a magnetic field of a permanent magnet that is located in the neutralization strand. The provision of a neutralization strand prevents undesired acceleration of the drive track caused by the approach of a permanent magnet of the rotor toward the travel path arrangement, and undesired deceleration of the drive track caused by movement of a permanent-magnet arrangement away from the travel path arrangement. The activatable neutralization magnet arrangement can encompass or be constituted by an electromagnet or an electromagnet arrangement. Activation of such a neutralization magnet arrangement can be effected by energization of the electromagnet or electromagnet arrangement. The neutralization arrangement can furthermore encompass one and/or several detectors for determining the magnetic field of the permanent magnet or magnets that is/are located in the neutralization strand, so that energization of the electromagnets of the neutralization arrangement can be regulated and/or controlled in coordination with the magnetic field, thereby determined, of the permanent magnet or magnets located in the neutralization strand.

The neutralization magnet arrangement is, in particular, separate from and in addition to the permanent magnets of the rotor, in particular is provided in stationary fashion with respect to the load subassembly.

When a “strand” of the drive track is referred to in the context of this Application, it is to be understood as a portion of the at least intermittently circulating drive track which is located in a substantially stationary spatial portion with respect to at least a portion of the load subassembly. A supporting surface contact strand, during normal operation of the tracked vehicle, is that spatial portion in which the drive track contacts a track supporting surface of a travel path arrangement or a surface, for example a road, that is to be traveled on. A deflection strand is a strand arranged between two further strands, such that in the deflection strand the drive track proceeds in a different direction than in the two strands adjacent to the deflection strand, and/or such that in the deflection strand, the circulation path of the drive track changes direction. A deflection strand can be arranged, for example, between a further deflection strand of the drive track and a supporting surface contact strand of the drive track. As a rule, the supporting surface contact strand is located between two deflection strands.

The drive track can encompass one supporting surface contact strand and at least two deflection strands, and each deflection strand can directly adjoin the supporting surface contact strands along the circulation path. The neutralization strand can encompass a portion of the supporting surface contact strand directly adjacent to one of the deflection strands, and/or can encompass a portion of the drive track in a transition region between the supporting surface contact strand and a deflection strand, and/or can encompass a portion of the supporting surface contact strand or the entire supporting surface contact strand. A conforming surface or conforming plane of the supporting surface contact strand can intersect with a conforming surface or conforming plane of a deflection strand, preferably along an intersection line orthogonal to the advance direction of the tracked vehicle. When the tracked vehicle is traveling as intended straight ahead on the track supporting surface, the supporting surface contact strand is in direct contact with the track supporting surface, and at least one, preferably both, of the deflection strands are spaced away at least in portions from the track supporting surface in a context of straight-ahead travel as intended.

In order to increase its stability and/or steerability, the tracked vehicle can encompass a plurality of drive tracks; more preferably, each of a plurality of drive tracks is embodied like the drive track described above. In particular, at least one of, a plurality of, or preferably each of the drive tracks encompasses a rotor of a linear motor which drives the drive track and which, in particular, is provided in stationary fashion with respect to the load subassembly. Each of the rotors can be arranged for motion together with the respective drive track and/or can be embodied in the drive track; the rotor can comprise permanent magnets that are arranged in the drive track and embodied for motion together with the drive track.

By a linear motor arranged in a stationary fashion with reference to the load subassembly is meant in particular a linear motor whose stator is arranged stationary with respect to the load subassembly and whose rotor can move relative to the load subassembly.

A load subassembly can carry one drive track with a runner or can carry more than one drive track with a runner circulating around it. A stator, as a circulating motion drive, can be associated with a drive track with rotor or can be associated with more than one drive track with a rotor. Therefore, a load subassembly can carry a linear motor, with exactly one or with more rotors, or can carry a plurality of linear motors with a plurality of rotors, wherein preferably the number of drive tracks carried on the load subassembly for circulating motion is equal to the number of stators. Preferably, the plurality of drive tracks, which are arranged in a circulating-movable manner on a load subassembly, circulate along parallel circulation paths on the common load subassembly. The aforementioned load receiving space, such as a cab or container, can be connected to the load subassembly in a movable or immovable manner relative to the load subassembly. In the case of a load receiving space immovably connected to and contained by the load subassembly, the drive track can circulate around the load subassembly such that it also circulates around the load receiving space.

If the tracked vehicle comprises a plurality of drive tracks, the dead load transferred to the track supporting surface of the substrate or of the travel path assembly and, if applicable, an added payload of the tracked vehicle is distributed among the individual drive tracks.

If the tracked vehicle comprises a plurality of load subassemblies, the totality of the load subassemblies provides for the aforementioned transmission of at least the dead load of the tracked vehicle via the then at least one drive track to the track supporting surface of the subgrade or of the travel path arrangement, with which the drive track or drive tracks are in contact.

If the load receiving space is offset perpendicular to the circulation path with respect to the circulation path of the drive track, preferably the area surrounded by an outer surface of the drive track is greater than a cross-sectional area of the load receiving space in a sectional plane that is parallel to the circulation path of the drive track. Preferably, this applies to all such cross-sectional areas of the load receiving space. Indeed, then the outer surface of the drive track can form an outer side of the track vehicle on more than two sides of the track vehicle, which considerably facilitates the above-mentioned change between differently inclined portions to be driven on, in particular between horizontal and vertical portions, of a travel path arrangement. The above-mentioned reference “perpendicular to the circulation path of the drive track” or/and “parallel to the circulation path of the drive track” can refer only to a portion of the circulation path of the drive track, but preferably refers to the entire circulation path of the drive track.

Regardless of whether or not the load receiving space is displaced/offset perpendicular to the circulation path with respect to the circulation path of the drive track, the outer surface of the drive track can form an outer surface of the tracked vehicle on more than two sides of the track vehicle, so that the above-mentioned change between portions to be driven on at different inclinations, in particular between horizontal and vertical portions, of a track arrangement is greatly facilitated. In particular, a drive track can circulate a load receiving space.

In order to reduce forces acting on individual segments of the drive track, it is advantageous to distribute over a maximally long portion of the drive track the forces that act simultaneously between the stator and the rotor arranged in the drive track; this is achieved by the fact that the drive track encompasses one supporting surface contact strand and two deflection strands, each deflection strand directly adjoining the supporting surface contact strand along the circulation path; and the stator comprising stator windings, arranged one behind another along at least a portion of the circulation path, for generating a magnetic field upon energization of the stator windings, which are arranged along at least one of the deflection strands and/or along the supporting surface contact strand and/or along a further strand of the drive track which differs from the supporting surface contact strand and is arranged between the deflection strands and/or, in a particularly preferred embodiment, are arranged along the entire circulation path.

The invention furthermore furnishes a vehicle system encompassing a tracked vehicle as has preferably been described above, and a travel path arrangement, the tracked vehicle encompassing: a load subassembly; a drive track having permanent magnets embodied for motion together with the drive track, the travel path arrangement comprising a track supporting surface that is embodied for abutting engagement with the drive track, i.e. is configured to come into direct contact with the drive track. The travel path arrangement preferably encompasses a magnetizable first carrying arrangement proceeding along the track supporting surface, the permanent magnets and the first carrying arrangement being embodied in such a way that a mutually attractive magnetic force acts between the permanent magnets and the first carrying arrangement as a result of a magnetic interaction between the permanent magnets and the first carrying arrangement. The provision of a magnetizable first carrying arrangement makes it possible to predetermine a motion path for the tracked vehicle. When an above-described tracked vehicle is used, stator windings are then provided only in the tracked vehicle, and not along the entire travel path arrangement as is the case e.g. with the “Transrapid” magnetic levitation train, so that costs can be reduced and less copper is needed for constituting the linear motor. The travel path arrangement can be of extremely simple configuration and can be retrofitted inexpensively, for example, in existing elevator shafts. Capture apparatuses, for example hooks, sawtooth profiles, counterpart rail elements, or the like can be arranged on the travel path arrangement; upon release of the drive track from the track supporting surface, these apparatuses engage into correspondingly embodied receiving elements for the capture apparatuses on the tracked vehicle, and thus prevent the tracked vehicle from falling.

The drive system of the tracked vehicle is preferably provided independently of the travel path arrangement, this allows the costs for a subsequent installation of travel path arrangement, e.g. in an elevator shaft, to be kept particularly low.

The track supporting surface can proceed at least in portions obliquely with reference to a plumb line, and/or at least in portions vertically, and/or at least in portions “overhead” (i.e. such that the tracked vehicle contacts the track supporting surface from below). In order to allow such track supporting surfaces to be traveled on, it is advantageous if the magnitude of the magnetic force is greater at least than 50%, preferably 75%, particularly preferably 100%, highly preferably 150% or 250%, of a weight force of a permissible total weight of the tracked vehicle; for travel in track supporting surfaces proceeding overhead, the magnitude of the magnetic force must be at least greater than 100% of the tracked vehicle.

The tracked vehicle is preferably configured to drive over at least one, preferably a plurality of or all of the track supporting surfaces mentioned in the preceding paragraph.

Likewise, the tracked vehicle is preferably configured to drive over a horizontally extending track supporting surface.

In order to guide and stabilize the motion of the tracked vehicle in the vehicle system, the travel path arrangement can comprise a travel channel whose course defines, at least in portions, a motion path of the tracked vehicle along the track supporting surface.

A self-centering effect that stabilizes the motion of the tracked vehicle, and/or a positive engagement of the tracked vehicle in the travel channel which acts in a transverse direction of the travel channel, can be achieved if the travel channel tapers in its depth direction in a direction toward the travel channel bottom.

In order for the tracked vehicle to advance on the track supporting surface with as little slippage as possible, the travel path arrangement preferably comprises projections and/or depressions arranged on the track supporting surface; and, also preferably, the drive track comprises depressions and/or projections on a supporting surface contact surface of the drive track, in such a way that upon direct contact between the track supporting surface and the supporting surface contact surface, a positive engagement is constituted which acts substantially parallel to a portion of the circulation path which is associated with the supporting surface contact surface. The supporting surface contact surface is, in particular, a portion of an outer surface of the drive track which is in contact with the track supporting surface, i.e. for example the outer surface of the supporting surface contact strand. The projections can be arranged in such a way that at least one projection, or a plurality of projections, is arranged in a space spanned by a depression. Preferably at least one of, a plurality of, or all of the projections are resiliently mounted and are preloaded into a position in which they engage into the depressions. The projections can preferably move back oppositely to their preload direction so that in the moved-back state they do not penetrate through, and are delimited by, the supporting surface contact surface, which abuts in particular in planar fashion against the track supporting surface and preferably not only against the projections themselves.

In a particularly preferred embodiment, the travel path arrangement encompasses a stationary travel portion that encompasses a portion of the track supporting surface and a portion of the first carrying arrangement. In this particularly preferred embodiment the travel path arrangement furthermore encompasses a transport portion that comprises a further portion of the track supporting surface which is at least temporarily adjacent to the travel portion, and a further portion of the first carrying arrangement. The further portion of the track supporting surface and the further portion of the first carrying arrangement are arranged in stationary fashion with reference to the transport portion. The transport portion, together with the further portion of the first carrying arrangement and the further portion of the track supporting surface, is furthermore arranged movably with reference to the travel portion. This makes it possible for the tracked vehicle to travel in the vehicle system from the travel portion onto the transport portion and then to be moved together with the transport portion, such that the motion can lead into a parked position of the transport portion or can result in a transfer position of the transport portion in which the tracked vehicle can leave the transport portion and continue on its way along a further portion of the track supporting surface. This further portion of the track supporting surface can be part of a further, in particular stationary, travel portion that encompasses that portion of the track supporting surface and a portion of a carrying arrangement, in particular the first carrying arrangement. The travel portion is, in particular, stationary with respect to a building wall or a building-mounted arrangement.

The position of the transport portion when the tracked vehicle moves from the travel portion onto the transport portion can be a first position of the transport portion, which is in particular identical to the transfer position or to a transfer position in the sense that the tracked vehicle crosses the transport portion along its motion path when the transport portion is not displaced. The first position, the parked position or/and the transfer position are preferably respective idle positions of the transport portion in which the transport portion does not move.

In particular, the transport portion is configured, alone and/or with the tracked vehicle arranged thereon, to be offset translationally and/or rotationally, preferably to be displaced, by means of an offset device, with the result that the transport portion, along with the loaded or unloaded tracked vehicle, can be moved to a desired location in the transport system.

The transport portion can be rotationally displaced by the offset device by performing a rotation of the transport portion about a rotation axis. This rotation axis of the transport portion is preferably aligned parallel to the motion path for the tracked vehicle, for which purpose the extension of the motion path is considered when the transport portion is in the first position or/and in the transfer position. The rotation axis of the transport portion is preferably aligned perpendicularly, i.e. in the direction of a plumb-line.

The travel path arrangement is arranged in particular on a wall surface of a building, in particular in a shaft-like or tunnel-like space, for example in an elevator shaft. The rotation axis of the transport portion can extend in the shaft- or tunnel-like space or also outside this shaft- or tunnel-like space, for example in its wall. The extension of the rotation axis of the transport portion outside this shaft- or tunnel-like space is preferred, since this moves the tracked vehicle due to displacement of the transport portion out of the shaft- or tunnel-like space, such that the shaft- or tunnel-like space is not blocked by the tracked vehicle, for example during loading of the tracked vehicle.

In order to park one or several transport portions, whether loaded with the tracked vehicle or unloaded, for further use, the vehicle system can furthermore encompass a receiving space, offset and/or offsettable with respect to the travel portion, which is embodied to receive a transport portion or encompasses a transport portion. The receiving space is preferably offset or offsettable, particularly preferably within a plane, orthogonally with respect to the motion trajectory of the tracked vehicle on the travel portion.

To allow a tracked vehicle to be able to travel along different motion paths, or a plurality of tracked vehicles to be able to travel on the travel path arrangement with as little interference as possible, the travel path arrangement preferably encompasses a second carrying arrangement that is arranged with an offset with respect to the first carrying arrangement, preferably offset orthogonally with respect to the direction in which the first carrying arrangement proceeds, the permanent magnets and the second carrying arrangement in particular being embodied in such a way that a mutually attractive magnetic force acts between the permanent magnets and the second carrying arrangement by way of a magnetic interaction between the permanent magnets and the second carrying arrangement. Preferably a portion of the track supporting surface which is embodied in particular for abutting engagement with the drive track, i.e. is configured to come into direct contact with the drive track, also proceeds along the second carrying arrangement.

In order to permit particularly efficient utilization of shaft-like or tunnel-like spaces, the first carrying arrangement can be arranged on a first side of the travel path arrangement, and the second carrying arrangement on a second side, located oppositely from the first side, of the travel path arrangement. The first carrying arrangement and the second carrying arrangement can also be arranged on one common side of the travel path arrangement, preferably in a common plane of extent, for instance a common wall surface, which makes possible in particular a simple transition from a motion along a path along the first carrying arrangement to a motion along a path along the second carrying arrangement of the tracked vehicle, those paths in particular also proceeding along the respective track supporting surfaces.

Preferably, the transport portion comprises on a first side a primary portion of the track supporting surface and a primary portion of the carrying arrangement, and comprises on a second side opposite to the first side a secondary portion of the track supporting surface and a secondary portion of the carrying arrangement. This is particularly advantageous if the rotation axis of the transport portion extends outside a shaft- or tunnel-like space, for example in its wall, since during a rotation about 180° a portion of the travel path arrangement occupied by a tracked vehicle (or an empty portion of the travel path arrangement) is rotated out of the shaft- or tunnel-like space while at the same time a new portion of the travel path arrangement takes its place, which portion can be empty or occupied by a tracked vehicle, as required.

In a particularly preferred embodiment, the above-described vehicle system is used to transport loads in and/or on a building, the travel path arrangement being arranged on and/or in a building; and the tracked vehicle encompassing an elevator cab and/or a load receiving arrangement. As compared with conventional elevators, the conveying height of the vehicle system is not limited by a weight of a lifting cable required for operation of the elevator in the context of a given motor output of the elevator, since the weight of the tracked vehicle which is to be moved is independent of the conveying height.

The vehicle system can furthermore encompass in particular a plurality of tracked vehicles that are moved simultaneously along a common motion path leading along the track supporting surface, in particular the motion path being embodied continuously, and preferably a distance along the motion path between two of the tracked vehicles being variable or varied. Because the travel path arrangement is embodied substantially as a passive element, it can be traveled on by the plurality of tracked vehicles similarly to a rail in a rail transport system, in particular because the above-described tracked vehicles, in contrast to usual elevator cabs, comprise a dedicated drive system mounted on the tracked vehicle. This makes it possible to use a single elevator shaft with a plurality of tracked vehicles and thus a plurality of elevator cabs, resulting in a significant decrease in construction costs thanks to the reduced number of elevator shafts, while the vehicle system has a high conveying capacity.

Although the arrangement of permanent magnets for movement together with the drive track, and preferably in fact in its chain links, produces particular capabilities in interaction with a ferromagnetic substrate, in principle the tracked vehicle can travel on any substrate. The latter can in fact be inclined, as long as the adhesion of the at least one drive track onto the respective substrate is greater than the downward force.

The permanent magnets are preferably arranged in a portion of the chain links which proceeds substantially parallel to the substrate when the chain link is located in the supporting surface contact strand. In order to minimize, on a substrate having a ferromagnetic carrying portion, an air gap between the permanent magnet and the carrying portion, the permanent magnets can be arranged, with reference to their circulation path, in radially outwardly exposed fashion on the at least one drive track, in particular on the chain links thereof.

Further, the permanent magnets can form, or at least contribute to the formation of, a contact area of the drive track with the substrate to be driven on.

Preferably, permanent magnets located in at least a portion of the supporting surface contact strand or in the entire supporting surface contact strand are arranged along a first plane when the vehicle is traveling on a level substrate or is stationary on a level substrate. Preferably, a magnetic polarization direction of at least one of the, preferably of all, permanent magnets, which are located in at least a portion of the supporting surface contact strand or which are located in the entire the supporting surface contact strand, extends substantially transvers, preferably perpendicular, to the first plane. In a preferred embodiment, the stator of the linear motor extends substantially parallel, or parallel, to said first plane. Alternatively or additionally, a plurality or all of the stators of the linear motor can be arranged along a second plane which extends substantially parallel, or parallel, to the first plane. In particular during travel or during standing on a level substrate or on a travel path arrangement, the first plane can be parallel to the track supporting surface of the substrate or of the travel path arrangement, in which case the track supporting surface is substantially a plane, preferably is a plane.

Because of the magnetic-inductive interaction between the permanent magnets of the drive track and the stator or the individual stator windings, the linear motor constituted by the drive track and stator can also be used as a “linear brake” or linear generator for regenerative deceleration of the tracked vehicle. A linear brake can be implemented by simply respectively short-circuiting stator windings of the same phase. In regenerative braking, the current induced by the permanent magnets in the stator windings is fed back into the power grid and/or into an electrical energy source. The power converter is then embodied to recover braking energy.

In order to reduce wear on the at least one drive track when magnetic interaction is not important in a travel mode, the tracked vehicle can comprise a lifting apparatus that is braced with a frame-side working end against the load subassembly (for stability reasons, in particular against the frame thereof), and whose other, track-side working end is embodied for transferring a lifting force onto a portion of the supporting surface contact strand. The lifting apparatus is thus embodied to lift a portion of the supporting surface contact strand away from the substrate currently being traveled on, forming a gap between the substrate and the lifted-off portion of the supporting surface contact strand. The lifting apparatus can comprise a mechanical, electromechanical, magnetic, and/or fluid-actuated actuator that, for example, can shift onto a portion of a track guidance structure orthogonally to its circulation path.

When the Application refers to a portion of an element located “downward” with respect to a reference direction, or to an end of an element located “downward” with respect to a reference direction, a viewing direction between the selected reference point in the element and the portion located downward with respect to the reference direction, or the end of the element located downward with respect to the reference direction, then proceeds parallel to and co-directionally with the reference direction.

When the Application refers to a portion of an element located “upward” with respect to a reference direction, or to an end of an element located “upward” with respect to a reference direction, a viewing direction between the selected reference point in the element and the portion located upward with respect to the reference direction, or the end of the element located upward with respect to the reference direction, then proceeds antiparallel and to counter-directionally with to the reference direction.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 shows an embodiment according to the present invention of a tracked vehicle;

FIG. 2 shows a portion of a drive track;

FIG. 3a is a schematic depiction of a portion of an embodiment according to the present invention of a tracked vehicle having a neutralization strand;

FIG. 3b is an enlargement of portion F3b of FIG. 3a;

FIG. 4 schematically depicts an embodiment according to the present invention of a tracked vehicle;

FIG. 5a shows an embodiment according to the present invention of a tracked vehicle;

FIG. 5b shows the tracked vehicle of FIG. 5a with a rotated retaining platform;

FIG. 6 shows a securing system for the drive track;

FIG. 7a schematically depicts an embodiment according to the present invention of a tracked vehicle;

FIG. 7b is an enlargement of portion F7b of FIG. 7a;

FIG. 8a schematically depicts an embodiment according to the present invention of a tracked vehicle;

FIG. 8b is an enlargement of portion F8b of FIG. 8a, a change in perspective having been made;

FIG. 8c is an enlargement of portion F8c of FIG. 8a, a change in perspective having been made;

FIG. 9 schematically depicts a modification of the tracked vehicle of FIG. 1;

FIG. 10 shows an embodiment according to the present invention of a vehicle system;

FIG. 11 shows a portion of the vehicle system of FIG. 10;

FIG. 12a shows a transition from a vertically proceeding portion of a track supporting surface to a horizontally proceeding portion of a track supporting surface, with a tracked vehicle in a first position;

FIG. 12b shows the transition of FIG. 12a with the tracked vehicle in a second position;

FIG. 13 is a view of a use according to the present invention of the vehicle system of FIG. 10;

FIG. 14a is a view of a use according to the present invention of a vehicle system;

FIG. 14b is an enlargement of portion F14b of FIG. 14a, a change in perspective having been made;

FIG. 14c is an enlargement of portion F14c of FIG. 14a, a change in perspective having been made;

FIG. 15 is a view of a use according to the present invention of a vehicle system; and

FIG. 16 shows an embodiment of a vehicle system according to the invention.

### DESCRIPTION OF PREFERRED EMBODIMENTS

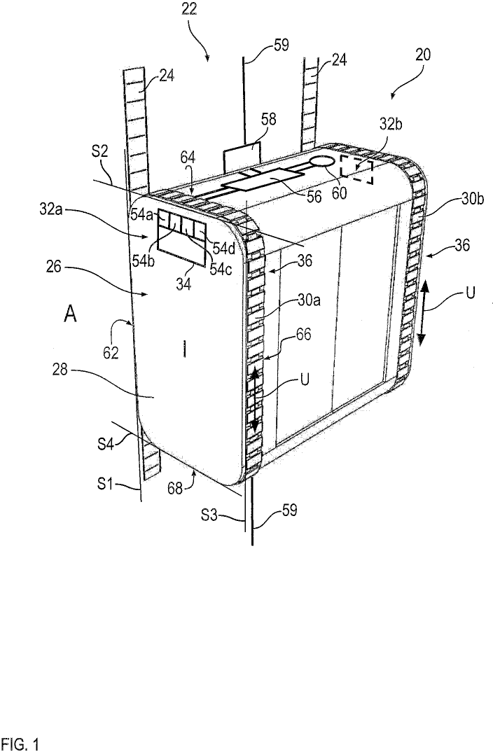

Referring now to the drawings wherein the showings are for the purpose of illustrating preferred and alternative embodiments of the invention only and not for the purpose of limiting the same, FIG. 1 shows a tracked vehicle 20 that is embodied as an elevator cab. The elevator cab is an embodiment of a load receiving space. Tracked vehicle 20 moves along a travel path arrangement 22 that is embodied with two travel channels 24, although embodiments having only one travel channel 24, or having more than two travel channels, 24, are likewise conceivable. Tracked vehicle 20 encompasses a load subassembly 26 that encompasses an external housing 28 as well as a vehicle frame (not shown) therein. Tracked vehicle 20 furthermore encompasses two drive tracks 30a, 30b that are each retained movably around load subassembly 26 along their circulation path U, and each circulate around the load subassembly. Also conceivable are embodiments in which track chains 30a, 30b are arranged entirely above, next to, or below housing 28. Tracked vehicle 20 furthermore encompasses a linear motor 32a, preferably one for each drive track 30a, 30b. In the interest of clarity, only one linear motor 30a for drive track 30a is shown in FIG. 1; the description of linear motor 32a is also to be applied correspondingly to a second linear motor 32b driving drive track 30b, and to its interaction with second drive track 30b, linear motor 32b not being depicted in the Figures. The description of drive track 30a, the description of its strands, and the description of its interaction with other parts of the tracked vehicle and/or with parts of the vehicle system described below are also to be used for drive track 30b, its strands, and its interaction with other parts of the tracked vehicle and/or with parts of the vehicle system described below. It is also possible, however, for only drive track 30a to be driven by a linear motor. Each of linear motors 32a, 32b can be regulated and/or controlled in particular with reference to the speed of its rotor and the direction in which its rotor moves. Each of the drive tracks described in this Application can be embodied like drive track 30a or 30b. Linear motors 32a, 32b can constitute a linear permanent-magnet synchronous motor.

When “regulation and/or control” processes are referred to in this Application, these can be executed by a regulation apparatus and/or control apparatus that is not shown, for example a microcontroller having a connected power electronics system. The regulating apparatus can be arranged in stationary fashion on load subassembly 26. The wiring of the respective subassemblies and/or elements which is required for regulation and/or control is not shown in order to ensure clarity in the Figures, but can be implemented by one skilled in the art in the context of his or her general technical ability and knowledge.

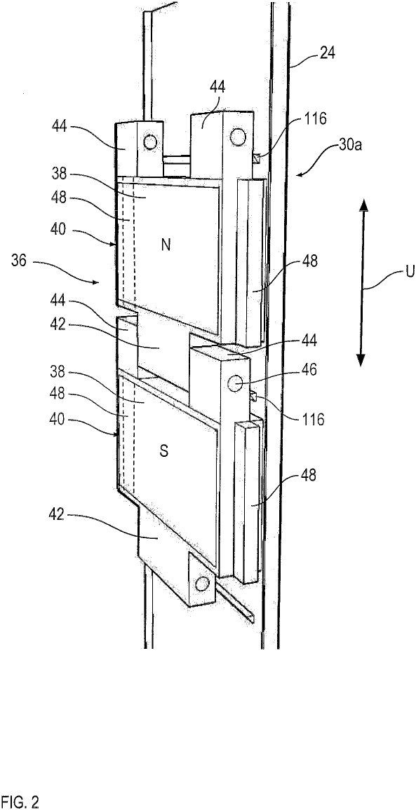

Linear motor 32a encompasses a stator 34 that is arranged on the vehicle frame in stationary fashion with respect to housing 28. A rotor 36 of linear motor 32a is constituted by permanent magnets 38 (see FIG. 2) that are, in particular, rare-earth permanent magnets. Permanent magnets 38 are arranged in drive track 30a for motion together with drive track 30a.

As depicted in FIG. 2, each of drive tracks 30a, 30b can be embodied as a drive chain made up of individual chain links 40. Each chain link preferably encompasses a central bar 42 and two side bars 44. In the state assembled into a drive chain, central bar 42 engages between two side bars 44 of a chain link (depicted in FIG. 2) that is directly adjacent along circulation path U, and is secured rotatably on that directly adjacent chain link by way of a pin 46 passing through openings in central bar 42 and in the two side bars 44. This securing of directly adjacent chain links 40 is carried out until the drive chain is continuous.

One of permanent magnets 38 is arranged in each chain link 40, two chain links 40 that are directly adjacent along circulation path U of the drive chain comprising permanent magnets whose polarization directions are aligned alternatingly in opposite directions, as shown by the indication of the north (N) and south (S) magnetic poles. The polarization direction of the permanent magnets proceeds substantially perpendicularly to circulation path U, and preferably points in the direction from north pole N to south pole S into an internal region I of the drive track or into an external region A of the drive track located outside the drive track. In addition, at least one guidance element 48, preferably two guidance elements 48, on which slide grooves 50 and/or slide tongues 52 (which will be described later and are arranged on the load subassembly) can engage, can be embodied on one of, on a plurality of, or on all of chain links 40. A material of chain link 40 which surrounds permanent magnets 38 can be a metal or another suitable material. Alternatively, the chain link can be constituted from a permanent magnet, in particular a rare-earth permanent magnet.

Stator 34 of linear motor 32a encompasses stator windings 54a to 54d that are electrically conductively connected to a power converter 56 (embodied as a frequency converter) in order to energize stator windings 54a to 54d. Power converter 56 can be arranged and fastened on load subassembly 26. Upon energization of the stator windings, as is known, an alternating magnetic field is generated by means of which permanent magnets 38 constituting rotor 36 are caused to move. Details regarding this may be gathered by one skilled in the art, for example, from Boldea, I. and Nasar, S. (1997). Linear Electric Actuators and Generators. Cambridge: Cambridge University Press. Doi: 10.1017/CB09780511529641. In particular, the speed of linear motor 32a or 32b can be regulated and/or controlled by way of the frequency and/or phase of the alternating magnetic field generated by stator 34. Stator 34 can be referred to as a “primary” part and rotor 36 as a “secondary” part of linear motor 32a. Power converter 56 can encompass a regulation and/or control apparatus for regulating and/or controlling energization, but that regulation and/or control apparatus can also be embodied separately from power converter 56. It is preferred that stator 32 extend with its stator windings along the entire circulation path U of drive track 30a.

Power converter 56 is supplied with energy via a current collector 58 which is electrically conductively connected to it for energy delivery and which collects current, for example, via a wiper contact from a busbar or current collector rail 59. Alternatively or additionally, tracked vehicle 20 can encompass an energy reservoir 60 that is electrically connected to the power converter in order to supply it with energy, so that power converter 56 can continue to be supplied with energy even if, for example, current collector 58 is not collecting current from a busbar 59. Energy reservoir 60 can encompass a battery and/or a supercapacitor, or can be embodied thereby individually or in combination.

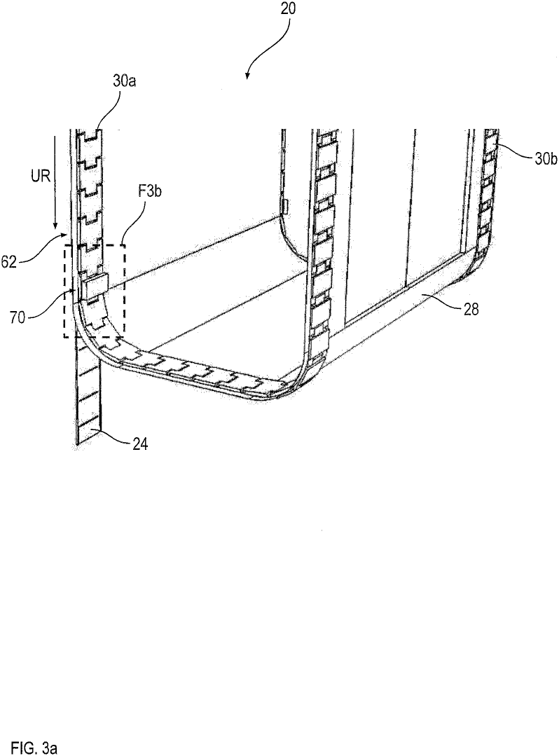

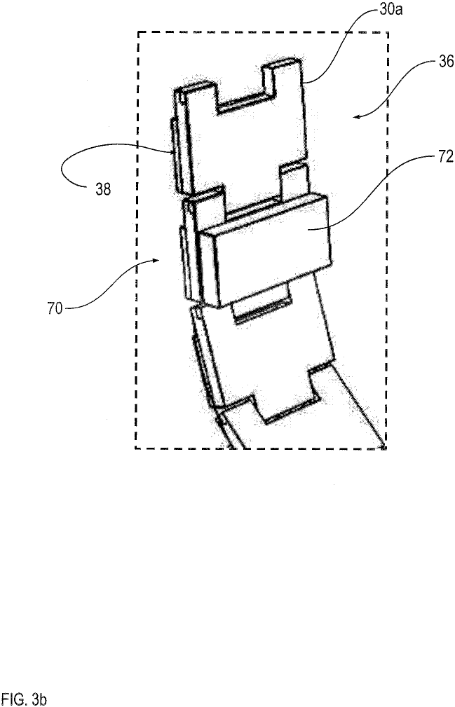

As is evident from FIGS. 1, 3a, and 3b, drive track 30a encompasses a supporting surface contact strand 62 having an associated conforming plane S1, as well as three deflection strands: a deflection strand 64 having an associated conforming plane S2, a deflection strand 66 having an associated conforming plane S3, and a deflection strand 68 having an associated conforming plane S4. The conforming planes conform to the respectively associated strand, and are indicated in FIG. 1 merely with lines. Conforming plane S1 intersects with conforming planes S2 and S4. It is also possible to categorize the curved portion of drive track 30a, located between the two above-described substantially straight strands, as one of the deflection strands. In a preferred embodiment that is not, however, depicted, stator 34 encompasses stator windings arranged one behind another along the entire circulation path U of drive track 30 for generating a magnetic field upon energization of the stator windings.

Stator 34 can encompass a plurality of separately and mutually independently controllable stator portions, a stator portion being controlled by the fact that the stator windings arranged in it are or are not individually or collectively energized. The decision as to whether windings in the respective stator portion are or are not energized can depend on the drive force required for driving the drive track. The position of drive track 30a, 30b along its circulation path relative to load subassembly 26 can also be determined using a position detection device of tracked vehicle 20; and in that case only those stator windings which are located in stator portions in whose vicinity a respective permanent magnet 38 is located can be energized. In particular, a permanent magnet 38 is located in the vicinity of a stator portion if, when viewed substantially perpendicularly to the circulation path in a direction from internal space I into external space A, the respective stator portion overlaps, in particular substantially completely overlaps, a permanent magnet 38.

In order to decide which stator portions are energized, in a first method step the position of drive track 30a, 30b relative to load subassembly 26 can be determined. Because the arrangement of permanent magnets 38 in drive track 30a, 30b is preferably substantially defined, and the arrangement of the stator portions relative to load subassembly 26 is substantially defined, in a second method step it is possible to determine, on the basis of that information, those stator portions in whose vicinity at least one of permanent magnets 38 is located. In a third method step, the stator portions in whose vicinity at least one of permanent magnets 38 is located in accordance with the second method step are energized. These steps can be repeated in a loop in order to drive drive track 30a.

As will be explained later with reference to the further system, tracked vehicle 20 shown here can contact, with each of strands 62 to 68 that are shown, a track supporting surface or also, in part, a surface being traveled on, and can travel on it. One of deflection strands shown in FIGS. 1, 3a, and 3b can correspondingly, upon contact with a track supporting surface or with a surface to be traveled on, also become a supporting surface contact strand, and the above-described supporting surface contact strand 62 can become a deflection strand that is not a supporting surface contact strand.

As shown in FIGS. 3a and 3b, drive track 30a encompasses a neutralization strand 70 that encompasses a portion of supporting surface contact strand 62 which is arranged, with respect to circulation direction UR, at the downward end of supporting surface contact strand 62. Provided on neutralization strand 70, for example in stationary fashion with respect to load subassembly 26, is a controllable electromagnet 72 for constituting a magnetic field that weakens or neutralizes the magnetic field of permanent magnet 38 of rotor 36 which is embodied in drive track 30a and is located in neutralization strand 70. Electromagnet 72 is an embodiment of a neutralization magnet arrangement. Because the polarization direction of the permanent magnets in drive track 30a is alternating, the polarization direction of the magnetic field constituted by electromagnet 72 must also be able to alternate, and this is achieved by changing the current direction in the context of energization of electromagnet 72. Thanks to the magnetic field of the electromagnet, permanent magnet 38 of rotor 36 in drive track 30a which is located in neutralization strand 70 can easily be released from the travel path arrangement. Additionally or alternatively, an identically or correspondingly constructed further neutralization strand of drive track 30a, 30b can also be provided, which strand encompasses a portion of supporting surface contact strand 62 which is arranged at the upward end of supporting surface contact strand 62 with respect to circulation direction UR. This further neutralization strand permits substantially smooth and substantially noiseless contact between a chain link 40 of drive chain 30a which is equipped with a permanent magnet and is located in the further neutralization strand, and the track supporting surface of travel path arrangement 22.

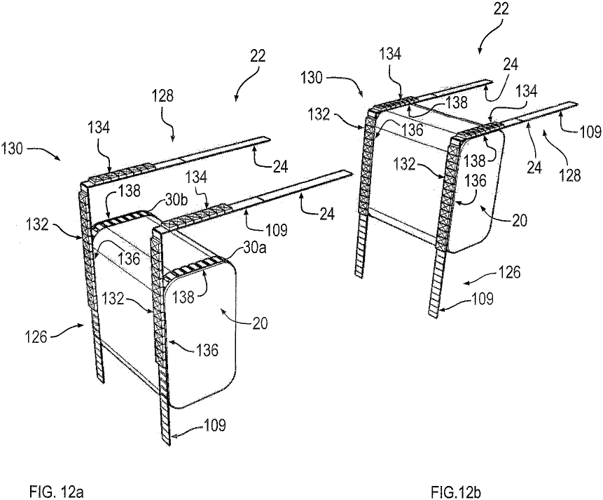

It is also possible for the entire supporting surface contact strand 62 or even the entire drive track 30a to be part of the, or a, neutralization strand. These embodiments permit release of an entire portion of drive track 30a from the track supporting surface, or contact between an entire portion of drive track 30a and the track supporting surface, for example supporting surface contact strand 62, to be implemented in a context of a weakened or neutralized magnetic field of permanent magnets 38 arranged in that portion of drive track 30a; this is advantageous in particular in the context of changes in direction, as will be described below in conjunction with FIGS. 12a and 12b.

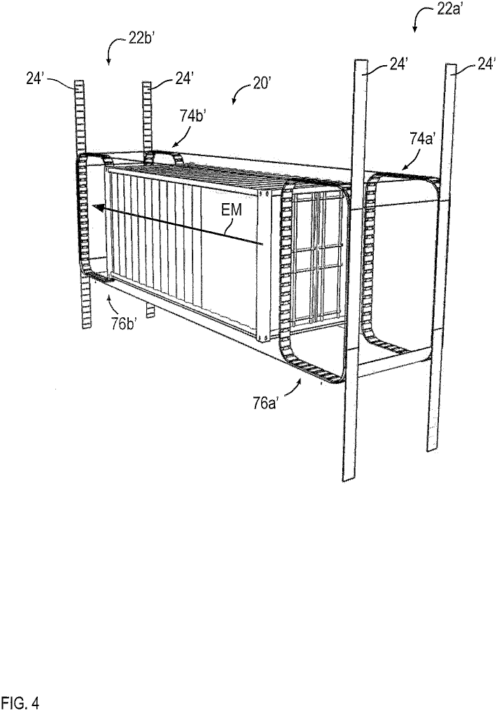

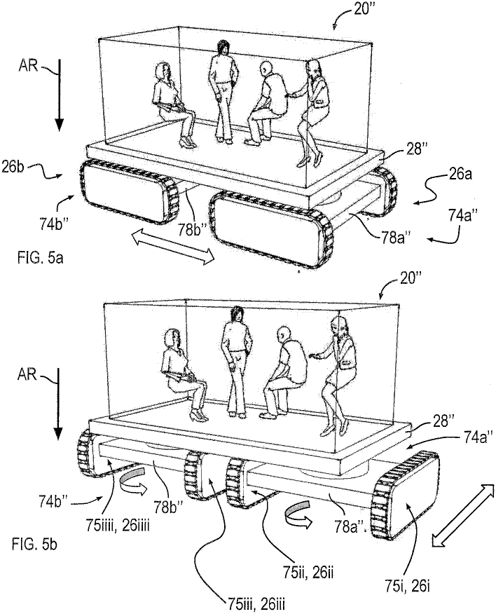

Tracked vehicle 20 described above comprises two drive tracks 30a, 30b. In a further embodiment (see FIG. 4 and FIGS. 5a and 5b) a tracked vehicle 20', 20" shown therein can encompass two or more pairs 74a', 74b'; 74a", 74b" of drive tracks. Tracked vehicle 20' can have a maximum direction of extent EM, and pairs 74a', 74b' of drive tracks can be arranged at end portions 76a', 76b' of the tracked vehicle with respect to maximum direction of extent EM.

Tracked vehicle 20" can have a support direction AR pointing toward a surface to be traveled on or toward a travel path arrangement, and pairs 74a", 74b" of drive tracks can be arranged on a side of housing 28" of tracked vehicle 20" which faces away from it in direction AR. In particular, each of pairs 74a", 74b" of drive tracks can be arranged on a retaining platform 78a", 78b" that is rotatable with respect to housing 28" in a plane substantially perpendicular to support direction AR and is associated with the respective pair of working tracks. Because each retaining platform 78a", 78b" is rotatable around a rotation axis parallel to support direction AR, tracked vehicle 20" can align retaining platforms 78a", 78b" with no motion of its housing 28" relative to the surface to be traveled on or relative to a travel path arrangement (see FIGS. 5a and 5b) and can thereby head in any travel direction. When a “tracked vehicle 20" is mentioned in the context of this Application, this can therefore also refer to an embodiment of tracked vehicle 20' and 20". Except for the differences described, tracked vehicles 20' and 20" can be embodied like tracked vehicle 20.

Frames 75i, 75ii are connected to the retaining platform 78a" and frames 75iii, 75iiii are connected to the retaining platform 78b". Each of the frames 75i, 75ii is circulated by a respective one of the pair 74a" of drive tracks, each of the frames 75i, 75ii carrying a stator of a linear motor which drives the drive track circulating this frame. A respective motion guide is attached to each of the frames 75i, 75ii guiding the drive track circulating this frame. Further, each of the frames 75iii, 75iiii is respectively circulated by a drive track of the pair 74b" of drive tracks, each of the frames 75iii, 75iiii carrying a stator of a linear motor which drives the drive track circulating this frame. A respective motion guide is attached to each of the frames 75iii, 75iiii guiding the drive track circulating this frame.

Thus, each drive track of the drive track pairs 74a", 74b" is supported in a circulating manner by a load subassembly 26i, 26ii, 26iii, 26iiii formed by a frame 75i, 75ii, 75iii, 75iiii which load subassembly also supports the stator associated with the respective drive track for magnetic interaction. In the example shown, the load subassemblies of a pair of drive tracks are structurally united forming each a common load subassembly 26a, 26b of each of the respective pair 74a", 74b" of drive tracks, the common load subassembly 26a comprising the frames 75i, 75ii and the retaining platform 78a" and the common load subassembly 26b comprising the frames 75iii, 75iiii and the retaining platform 78b". It is noted that a common load subassembly is an embodiment of a load subassembly.

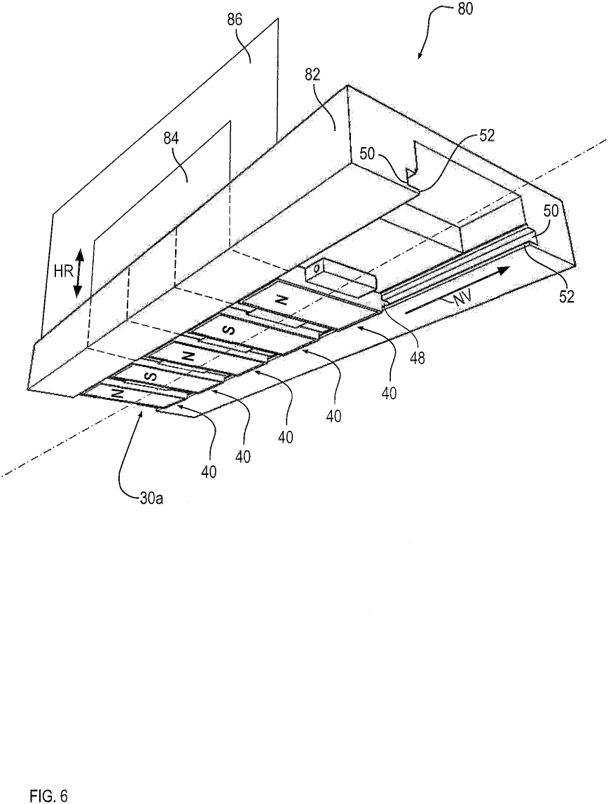

As shown in FIG. 6, to secure drive track 30a, each of the two guidance elements 48 of a chain link 40 preferably engages into an associated slide groove 50 of a guidance arrangement 80, fastened on load subassembly 26, of tracked vehicle 20. Drive track 30a is thereby retained on tracked vehicle 20, in particular in a context of overhead travel, which can assist adhesion to a travel path arrangement resulting from the attractive magnetic force produced by permanent magnets 38, since the individual chain links 40 can be tilted less severely with respect to the track supporting surface as compared with a case in which no guidance arrangement 80 is provided. In addition, slide groove 50 also ensures a defined relative spatial arrangement relative to stator 34, and thus ensures a defined air gap between rotor 36 and stator 34.

Guidance arrangement 80 can comprise in stationary fashion, in particular in locally stationary fashion, slide grooves 50 which are arranged on load subassembly 26 and are embodied, for example, in a U-profile 82 arranged in stationary fashion on load subassembly 26. The two slide grooves 50 are preferably embodied parallel to one another. Alternatively, U-profile 82 can be arranged in only locally stationary fashion on load subassembly and can encompass, as indicated by the dashed lines, segments which are movable relative to one another by way of a motion arrangement 84 and are movable in lifting directions HR. Lifting directions HR proceed substantially perpendicularly to groove extent direction NV and/or substantially perpendicularly to a conforming plane, proceeding parallel to the two slide grooves 50, of drive track 30a. Alternatively or additionally, guidance arrangement 80 can be movable relative to load subassembly 26 in lifting directions HR by means of a lifting apparatus 86. Motion arrangement 84 and/or lifting apparatus 86 can be driven mechanically, hydraulically, electrically, and/or pneumatically. Each of slide grooves 50 forms, together with the associated guidance element 48, a tongue-and-groove connection configured for sliding. A corresponding tongue can of course be arranged on U-profile 82 and a groove on chain link 40 in order to achieve a corresponding effect, this being possible on both sides of chain link 40 and of U-profile 82. In order to prevent chain links 40 from lifting away from load subassembly 26, it is sufficient to provide, instead of the groove, only a slide tongue 52 that is depicted, in the embodiment illustrated in FIG. 6, as a flange or plate that engages behind guidance element 48 and is arranged on that side of guidance element 48 which faces toward the track supporting surface of a travel arrangement that is being traveled on. A slide tongue 52 can be embodied independently of the remainder of a groove 50.

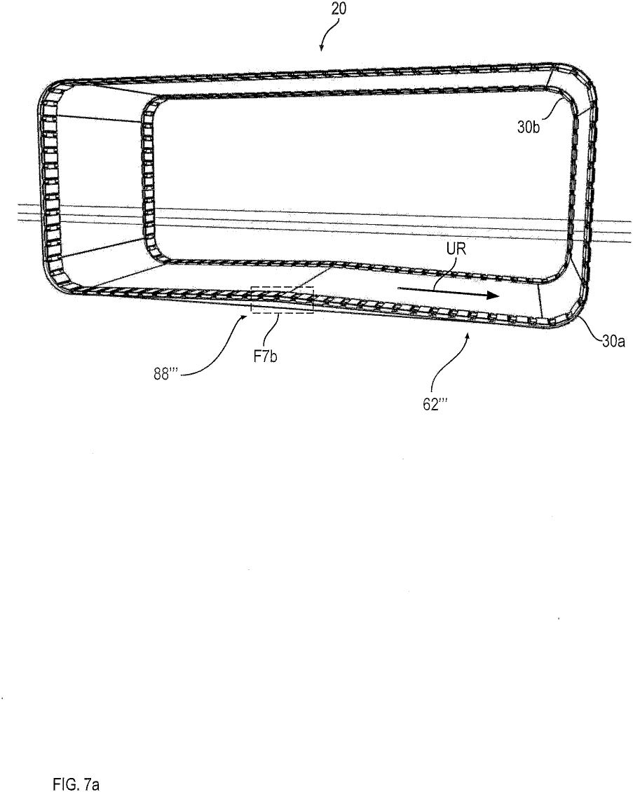

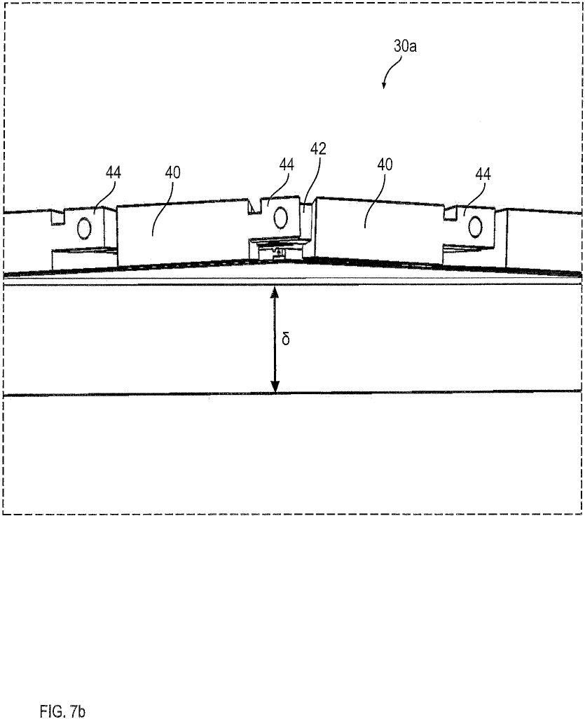

As shown in FIGS. 7a, 7b, it is preferred that supporting surface contact strand 62"' encompass a lifting strand 88"' that, especially when tracked vehicle 20 is operated to travel on a non-magnetizable surface, can be lifted a predetermined height δ away from the surface being traveled on, for instance using an above-described U-profile 82 having a lifting apparatus 86 and/or motion arrangement 84, in order to reduce the contact area of supporting surface contact strand 62"' with the surface to be traveled on.

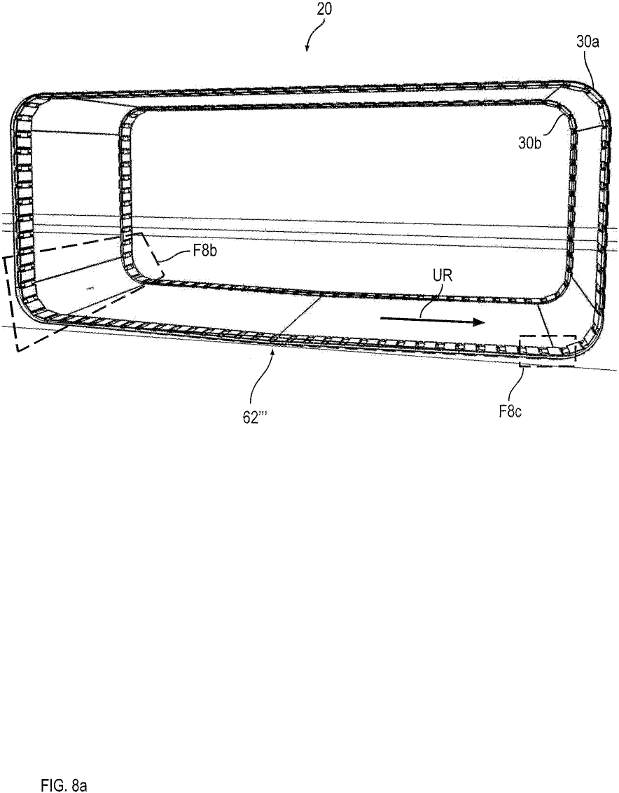

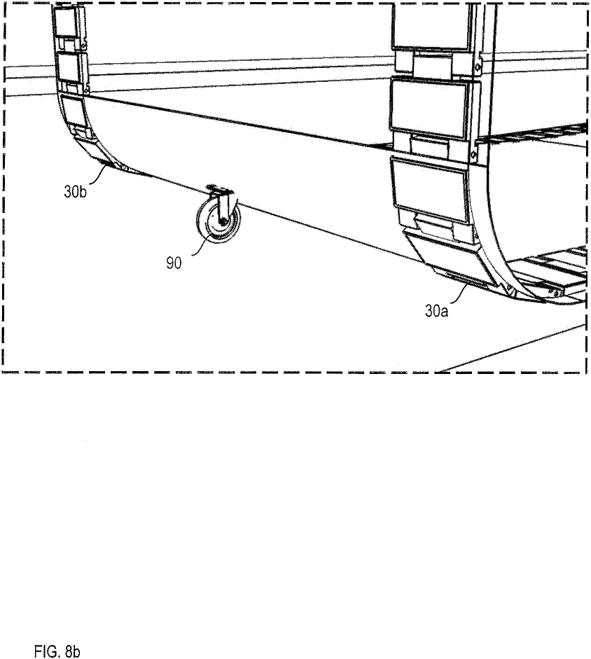

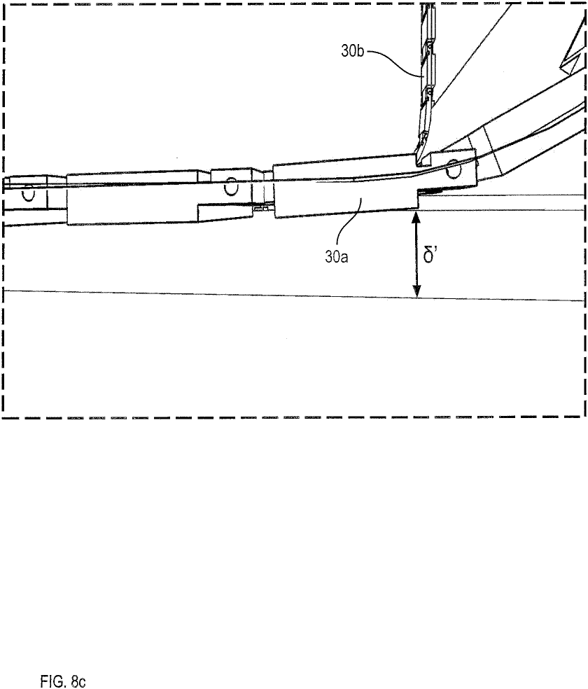

This reduces the shear forces and frictional forces acting on drive track 30a, 30b, or its chain links 40, when maneuvering. Lifting strand 88"' can encompass in particular a center portion of supporting surface contact strand 62"', but in an embodiment that is not depicted, the lifting strand can be embodied in one piece or in two parts, and can be arranged at an end of supporting surface contact strand 62"' located downward with reference to a circulation direction UR of drive track 30a, and/or at an end of supporting surface contact strand 62'" located upward with reference to a circulation direction UR of drive track 30a. In a particularly simple embodiment shown in FIGS. 8a to 8c, an end of supporting surface contact strand 62"" located downward with reference to a circulation direction UR of drive track 30a, and/or an end of supporting surface contact strand 62"" located upward with reference to a circulation direction UR of drive track 30a, can respectively be lifted, by means of a mechanically, hydraulically, electrically, and/or pneumatically displaceable support roller 90, or a U-profile 82 (not shown) having a lifting apparatus 86 and/or motion arrangement 84, by an amount equal to a predetermined height δ', as indicated in FIG. 8c. Supporting surface contact strands 62, 62"', and 62"", and the arrangements described in conjunction with them, can be used in all embodiments of the tracked vehicles.

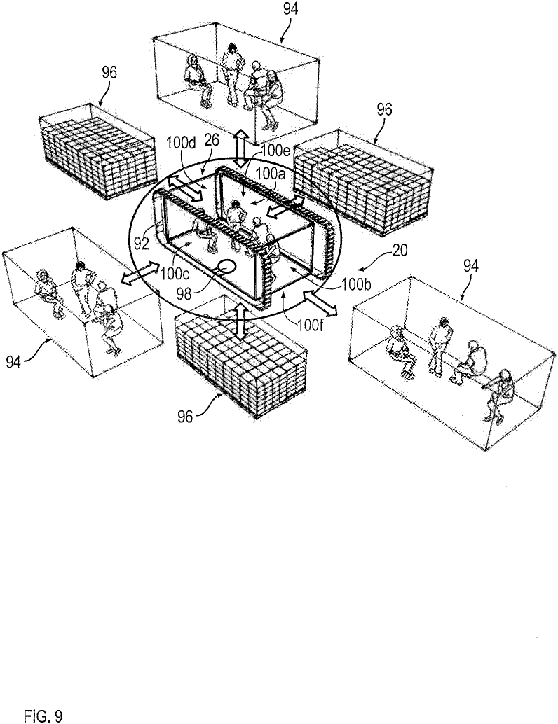

As depicted in FIG. 9, load subassembly 26 of tracked vehicle 20 can encompass a carrying frame 92 that is embodied for releasable reception of cab containers 94 for conveying passengers and/or load containers 96 for conveying loads. Tracked vehicle 20 encompasses for this purpose an interlock apparatus 98, which acts between each container from among cab containers 94 and load containers 96 and carrying frame 92 (depicted with heavier lines) and is configured to constitute a secure connection, releasable nondestructively as intended, between the respective container and carrying frame 92. Carrying frame 92 is preferably embodied with openings 100a to 100f through which cab container 94 and/or load container 96 can be received into an interior of carrying frame 92 for interaction with interlock apparatus 98, and from which said containers can be removed.

In a particularly preferred embodiment, there exists between stator 34 and rotor 36 of linear motors 32a, 32b, or between the stator and the rotor of each linear motor described here, an air gap that, upon energization of the stator, is held open during operation of tracked vehicle 26 as intended (analogously to a “maglev” process) by the interaction of the magnetic fields of the stator and of the rotor, such that the air gap has a gap dimension that is greater than zero, with no assistance from further support elements such as rollers, plain bearings, or the like, as a result of the dimensioning of the magnetic fields in the rotor and in the stator.

Tracked vehicle 20 described above not only can move on a travel path arrangement, but can also be used in ordinary road traffic, for instance with energy supplied via energy reservoir 60. The provision of two drive tracks 30a, 30b each driven by a linear motor 32a, 32b makes possible, as is usual with treaded vehicles, a rotation of tracked vehicle 20, around a rotation axis passing through tracked vehicle 20, on a road pavement or on a travel path arrangement. A drive system of this kind also permits a simplified parking motion that encompasses a plurality of zigzag motions.

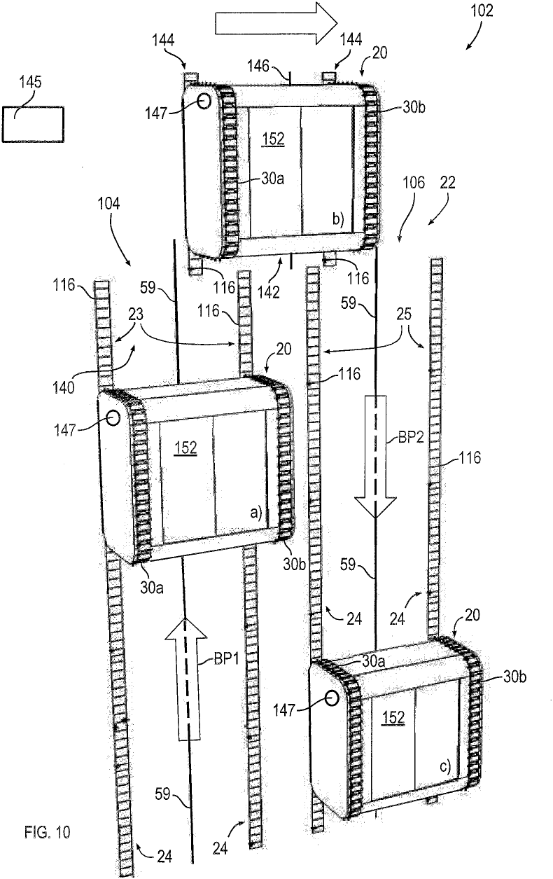

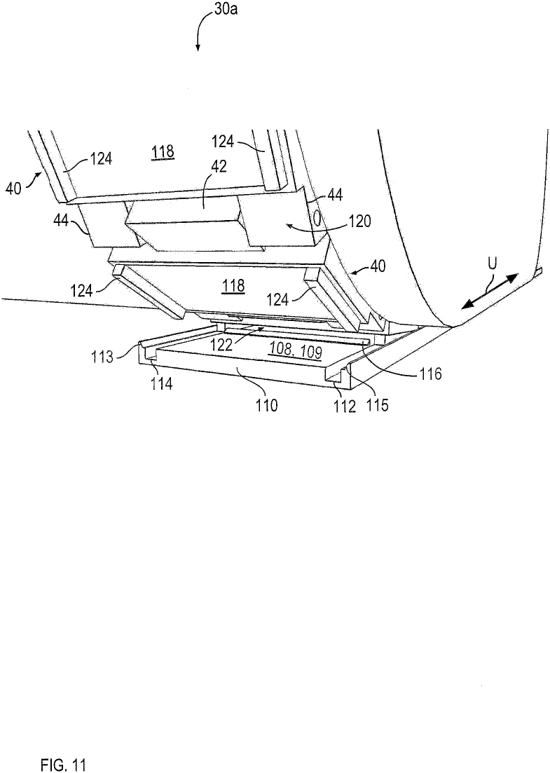

FIG. 10 shows an embodiment of a vehicle system 102, embodied as an elevator system, having three tracked vehicles 20 that have additionally been labeled with the letters a), b), and c) in order to simplify the description. Vehicle system 102 further encompasses travel path arrangement 22, which in this embodiment encompasses a first pair 104 of travel channels 24 and a second pair 106 of travel channels 24. Preferably each of travel channels 24 tapers in its depth direction toward travel channel bottom 108 (see FIG. 11). Travel channel bottom 108 is configured to come into contact with a drive track 30a, 30b of tracked vehicle 20, and is thus a portion or an embodiment of a track supporting surface 109. Travel channel bottoms 108 of a pair 104, 106 of travel channels 24 can, at least in portions or completely, constitute track supporting surface 109. Below travel channel bottom 108, or constituting travel channel bottom 108 at least in portions, travel path arrangement 22 encompasses a magnetizable plate 110, in particular a magnetizable steel or iron plate, which extends along the entire respective travel channel 24 and is an embodiment of a carrying arrangement 23. In particular, magnetizable plates 110 (or also a magnetizable plate arranged collectively under travel channels 24) that are arranged below travel channel bottoms 108 of travel channels 24 of first pair 104 of travel channels 24 can constitute an embodiment of a first magnetizable carrying arrangement 23, and/or magnetizable plates 110 (or also a magnetizable plate arranged collectively under travel channels 24) that are arranged below travel channel bottoms 108 of travel channels 24 of second pair 106 of travel channels 24 can constitute an embodiment of a second magnetizable carrying arrangement 25 that is offset with respect to first carrying arrangement 23 along a wall of an elevator shaft and is arranged on one common side together with first magnetizable carrying arrangement 23 of travel path arrangement 22. Travel channels 24, in particular each pair 104, 106 of travel channels 24, define motion paths BP1, BP2 of tracked vehicles 20 in the respective portions.

A mutually attractive magnetic force, which is produced by a magnetic interaction between carrying arrangement 23, 25 and permanent magnets 38, exists between the above-described carrying arrangement 23, 25 and permanent magnets 38 that constitute rotor 36 of linear motors 32a, 32b.

The combination of carrying arrangement 23, 25 and permanent magnets 38 is selected, for example by way of the dimensioning of magnetizable plates 110 and the strength of the magnetic field constituted by permanent magnets 38, in such a way that in a context of operation of tracked vehicle 20 as intended on travel path arrangement 22, the mutually attractive magnetic force exceeds a multiple of, for example ten times, a permissible gross weight of tracked vehicle 20 of, for example, 1.5 tonnes.

FIG. 11 is a detail view of a vehicle system 102 in which an engagement of drive track 30a, 30b into a travel channel 24 is shown. Travel channel bottom 108, which in this exemplifying embodiment constitutes track supporting surface 109, encompasses grooves 112, 114 arranged in the direction of extent of travel channel 24 as well as projections 116, of which only one is depicted in FIG. 11 but which are indicated in FIG. 10 by lines which traverse travel channels 24 and of which, in order to ensure clarity, only a few are labeled with reference characters. Central bar 42 and side bars 44 of each of chain links 40 are arranged, with reference to a chain link supporting surface 118 that constitutes a portion of a supporting surface contact surface 122 of the drive track, with an offset to the rear (from chain link supporting surface 118 toward internal region I [see FIG. 1]) in a thickness direction of chain link 40, thus forming in drive track 30a, 30b, as a result of that offset, recesses 120 and thus depressions into which projections 116 engage during operation of tracked vehicle 20 as intended in vehicle system 102. The result is to constitute, between track supporting surface 109 and supporting surface contact surface 122, a positive engagement that acts substantially parallel to that portion of circulation path U of drive track 30a, 30b which is associated with supporting surface contact surface 122. Rubber elements 124, for example rubber blocks or rods, which can engage into grooves 112, 114, can be arranged on chain link supporting surface 118 so that chain link supporting surface 118 comes into direct contact with travel channel bottom 108 during operation of vehicle system 102 as intended. A distance between projections 116 that are arranged one behind another, preferably directly adjacently, in a direction of extent of travel channel 24 corresponds to and/or equals in particular an extent of chain link 40 in a direction of extent of drive track 30a, 30b.

Conversely, when tracked vehicle 20 equipped with rubber elements 124 on drive track 30a, 30b is operated on a non-magnetizable substrate such as a road, rubber elements 124 then prevent contact between, for example, metallically constituted chain links 40 and that substrate, thereby protecting both the substrate and chain links 40 from wear; in particular, the magnets provided in chain links 40 are protected from wear. Grooves 112, 114 transition into inclined flanks 113, 115 that constitute a tapering of travel channel 24 toward travel channel bottom 108. Preferably one of, a plurality of, or each of projections 116 has a triangular cross-sectional area in a cross section transversely to its principal direction of extent, in which context the triangular cross-sectional area can comprise a right angle. The hypotenuse of a cross-sectional area of this kind can slope downward toward travel channel bottom 108, while a force producing the above-described positive engagement, which acts in a direction substantially parallel to that portion of circulation path U of drive track 30a, 30b which is associated with supporting surface contact surface 122, can act on the surface of projection 116 which forms the short side.

The alignment of track supporting surface 109 of travel path arrangement 22, which preferably can be constituted by the travel channel bottoms of the pairs of travel channels 24 shown in FIGS. 12a, 12b, can change, as shown in FIG. 12a, from vertical to horizontal and vice versa; only the transition from a vertically proceeding portion 126 of track supporting surface 109 to a horizontally proceeding portion 128 of track supporting surface 109 which is to be traveled on, from below in a gravitational direction, will be explained. The transition from a vertically proceeding portion of track supporting surface 109 to a horizontally proceeding portion of track supporting surface 109 which is to be traveled on from above in a gravitational direction is embodied analogously.

As shown in FIGS. 12a and 12b, portions 126 and 128 of track supporting surface 109 meet in a transition region 130, for example at an angle of substantially 90°. Arranged in portion 126, preferably on each of travel channels 24 of portion 126, is a plurality of electromagnets 132, which are embodied and controllable in such a way that they can neutralize or weaken a magnetic field of permanent magnets 38 of a strand of each of drive tracks 30a, 30b which is in contact with portion 126. Arranged in portion 128, preferably on each of travel channels 24 of portion 128, is a plurality of electromagnets 134, which are embodied and controllable in such a way that they can neutralize or weaken a magnetic field of permanent magnets 38 of a strand of each of drive tracks 30a, 30b which is in contact with portion 128. Hall sensors or other detectors are preferably provided in portions 126 and 128 in order to determine the orientation and strength of the magnetic fields of permanent magnets 38 in those portions of drive tracks 30a, 30b which contact the respective portions 126, 128. Electromagnets 132, 134 are preferably arranged on a side of the respective travel channel 24 directed oppositely from travel channel bottom 108.

When tracked vehicle 20 then moves along a vertical portion of track supporting surface 109 in portion 126, as shown in FIG. 12a, none of electromagnets 132 or 134 is energized, and strands 136 of drive tracks 30a, 30b respectively have the function of a supporting surface contact strand. When this motion is continued, so that strands 138 come into direct contact with portion 128, both strands 136 and strands 138 then have the function of supporting surface contact strands and adhere to the travel path arrangement with those strands 136, 138 due to the interaction of permanent magnets 38 with carrying arrangements (not explicitly depicted). The orientation and strength of the magnetic fields of permanent magnets 38 in strands 136 in the position shown in FIG. 12b is determined, for example, by the aforementioned Hall sensors, and in the next step electromagnets 132 are energized so that their magnetic fields weaken or neutralize the magnetic field of permanent magnets 38 in strands 136. The attractive force between tracked vehicle 20 and travel path arrangement 22 in the region of portion 126 is thereby reduced and/or canceled, so that an attractive force exists between tracked vehicle 20 and travel path arrangement 22 substantially only in the region of portion 128. Tracked vehicle 20 is set in motion again, and continues to move on the horizontally proceeding portion of track support surface 109 of travel path arrangement 22, suspended from it from below in a gravitational direction.

When tracked vehicle 20 moves in an opposite direction, starting on a horizontally proceeding portion of the track supporting surface of the travel path arrangement, the process of traversing transition region 130 is then similar to the process presented above, except that electromagnets 134 are used to weaken and/or neutralize the magnetic field of the permanent magnets in strands 138.

If strands 136, 138 are embodied as neutralization strands or encompassed by neutralization strands, the above-described weakening and/or neutralization of the magnetic field embodied by permanent magnets 38 arranged in strands 136, 138 can then be effected by the respective neutralization magnet arrangements, and electromagnets 132, 134 can be omitted.

A plurality of transition regions can constitute a continuous travel path arrangement. When the latter is traveled on by a tracked vehicle 20, each of its strands 62 to 68 then at least temporarily becomes a supporting surface contact strand.

As shown in FIG. 10, tracked vehicles 20 a) to c) move on a continuous path similarly to a paternoster lift, the top turning point of that path being depicted in FIG. 10.

First pair 104 of travel channels 24, having the associated portions of track supporting surface 109 and those portions of first carrying arrangement 23 which are arranged in travel channels 24, together with a framework (not shown), are an embodiment of a travel portion 140. Travel portion 140 is directly adjoined by a transport portion 142 that encompasses portions 144 of travel channels 24 which in turn, as described above, constitute portions of the track supporting surface and of first carrying arrangement 23. These portions can of course also be associated with second carrying arrangement 25. In addition, a portion 146 of busbar 59 can be arranged on transport portion 142. Transport portion 142 furthermore preferably encompasses a framework (not shown).

Transport portion 142 can be embodied as a plate, displaceable mechanically, hydraulically, electrically, and/or pneumatically by means of an offset device 145, having the aforementioned portions 144 and 146.

In a first idle position of transport portion 142, portions 144 of travel channels 24 are aligned flush with the travel channels of first pair 104 of travel channels 24, and portion 146 of busbar 59 is electrically conductively connected, for example by way of a wiper contact, to that portion of busbar 59 which proceeds between travel channels 24 of first pair 104 of travel channels 24.

In a second idle position of transport portion 142, portions 144 of travel channels 24 are aligned flush with the travel channels of second pair 106 of travel channels 24, and portion 146 of busbar 59 is electrically conductively connected, for example by way of a wiper contact, to that portion of busbar 59 which proceeds between travel channels 24 of second pair 106 of travel channels 24.

When tracked vehicle 20 (for example, tracked vehicle 20 a)) moves upward along first pair 104 of travel channels 24, it can travel onto transport portion 142 that is in the first idle position. Transport portion 142 can then be moved translationally from its first idle position into its second idle position. During this motion, energy reservoir 60 can furnish electrical energy for supplying energy to power converter 56. The attractive force between permanent magnets 38 and the carrying arrangement can exist in transport portion 142 even independently of the supply of energy, so that tracked vehicle 20 does not detach from transport portion 142. A relative motion with respect to load subassembly 26 of a drive track 30a, 30b is suppressed for that purpose, preferably using a braking apparatus 147. Once transport portion 142 reaches its second idle position, braking apparatus 146 can be released, and tracked vehicle 20 can continue to move downward along second pair 106 of travel channels 24, as shown e.g. for tracked vehicle 20 c) in FIG. 10.

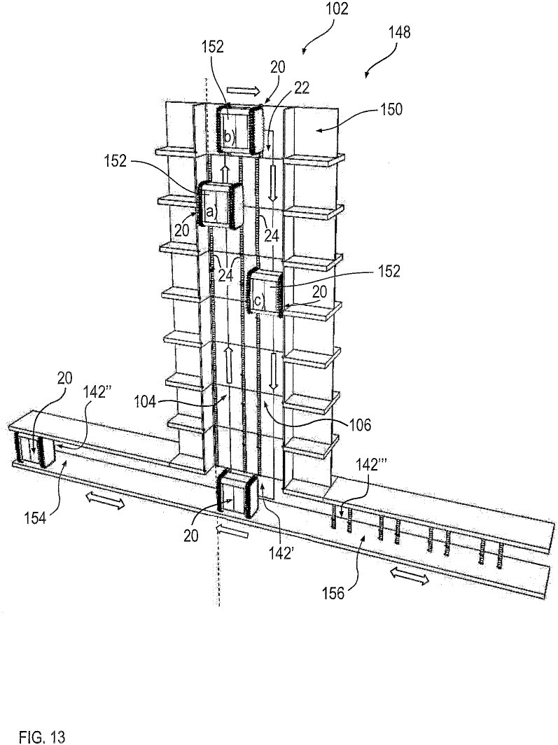

FIG. 13 is a view of a use of a vehicle system 102 of FIG. 10, as described above, in a building 148 for transporting loads, for instance passengers. Travel path arrangement 22 is arranged in particular on a building wall 150, and tracked vehicle 20 is embodied as an elevator cab. The transitions to building 148 through doors 152 of tracked vehicles 20 are not explicitly depicted in FIG. 13, since FIG. 13 is a schematic section through building 148, and an optional building-side door, through which tracked vehicle 20 can be boarded through via door 152, is not depicted in the schematic section. FIG. 13 furthermore shows the bottom turning point of the continuous path on which tracked vehicles 20 a) to c) move, which is likewise embodied with a transport portion 142'. Transport portion 142' is embodied, mutatis mutandis, like transport portion 142, and comprises at least a first and a second idle position as in the case of transport portion 142, so that tracked vehicles can also switch, via transport portion 142', between first pair 104 of travel channels 24 and second pair 106 of travel channels 24. It is to be noted that one of travel channels 24 of second pair 106 of travel channels 24 is not shown in FIG. 13 because of the perspective selected.

It is noteworthy that one of, a plurality of, or all of tracked vehicles 20 a) to c) can travel simultaneously on first pair 104 of travel channels 24 or on second pair 106 of travel channels 24; and because linear motors 32a, 32b are arranged in each of tracked vehicles 20 a) to c), that plurality of tracked vehicles can move simultaneously along the shared motion path, defined by first pair 104 or second pair 106 of travel channels 24, which is embodied continuously along at least first pair 104 of travel channels 24 and second pair 106 of travel channels 24. In contrast to a paternoster lift, however, the distance between the individual tracked vehicles 20 a) to c) is not defined, and the tracked vehicles can travel separately from one another to individual positions along the common motion path, limited only by collision avoidance. In addition, a tracked vehicle 20 that is located on transport portion 142' can be moved into a first receiving space 154, for example for maintenance or for storage, or a tracked vehicle 20 located on a transport portion 142" and received in first receiving space 154 can be moved into the first or second idle position of transport portion 142". If a transport portion is not present at the bottom turning point, a transport portion 142"' can be moved out of a second receiving space 156 into its first or second idle position at the bottom turning point. Transport portions can likewise be moved into second receiving space 156.

All the transport portions 142, 142', 142", and 142"' are preferably of similar or identical construction, and have respective first and second idle positions that correspond or are identical to those of transport portion 142.

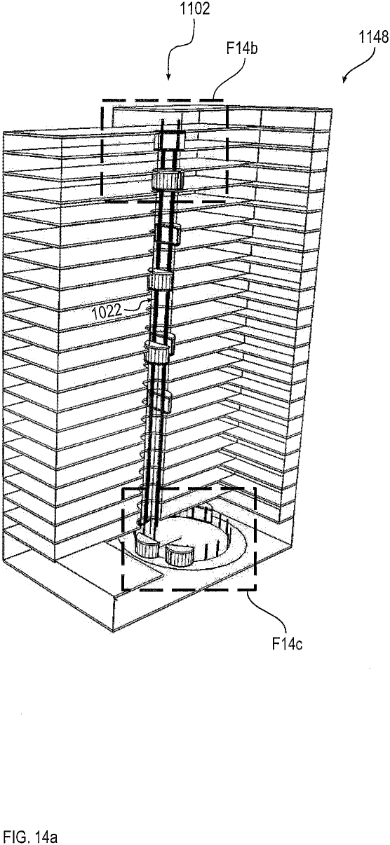

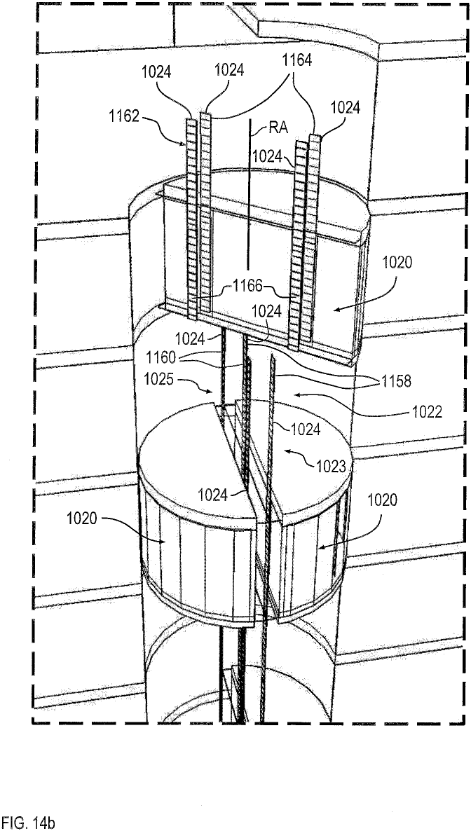

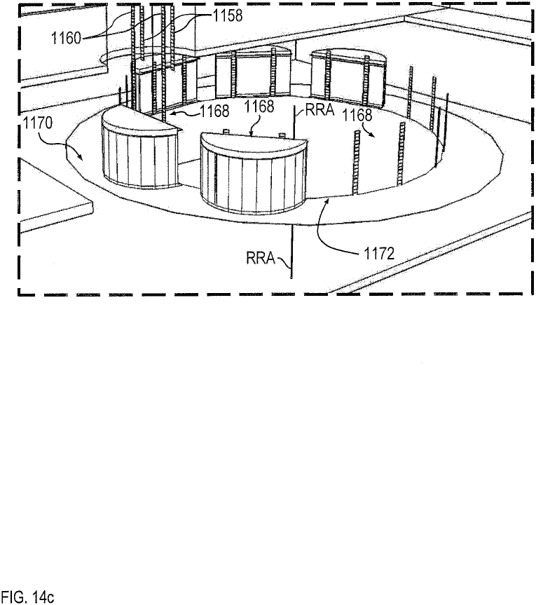

A second embodiment of vehicle system 1102 shown in FIGS. 14a to 14c will be described below, reference being made only to the differences with respect to the embodiment of vehicle system 102 and tracked vehicles 20 used therein. Reference is made to the first embodiment for a description of the further elements, parts, and subassemblies; in the second embodiment, elements, parts, and subassemblies are labeled with a reference character incremented by 1000 as compared with those elements, parts, and subassemblies of the first embodiment to which they correspond. Details of the embodiments are in some cases omitted from the Figures, but the aspects of the first embodiment of vehicle system 102 can be used for the second embodiment of vehicle system 1102.

Travel path arrangement 1022 encompasses a first pair 1158, arranged on a first side of travel path arrangement 1022, of travel channels 1024 proceeding in parallel, and a second pair 1160, arranged on a second side of travel path arrangement 1022, of travel channels 1024 proceeding in parallel, first side of travel path arrangement 1022 being arranged oppositely from second side of travel path arrangement 1022. Travel channels 1024 arranged on one side of the travel path arrangement encompass respective carrying arrangements. Arranged between first pair 1158 and second pair 1160 of travel channels 1024 is a retaining structure (not shown in the interest of clarity), preferably a retaining frame, on which first pair 1158 and second pair 1160 of travel channels 1024 are arranged in stationary fashion with respect to building 1148. First pair 1158 of travel channels 1024 preferably encompasses first carrying arrangement 1023, and second pair 1160 of travel channels 1024 preferably encompasses second carrying arrangement 1025. A busbar 1059 is associated with each pair 1158, 1160, but this is not shown in the Figures in the interest of clarity. Tracked vehicle 1020 comprises drive tracks which, except for a portion facing toward travel channels 1024 during operation as intended, proceed in tracked vehicle 1020 and are thus not visible in the Figures.

Vehicle system 1102 comprises, at least at the top turning point, a paternoster-lift-shaped motion path of the tracked vehicle, at least at the top turning point shown in FIG. 14. Travel path arrangement 1022 of vehicle system 1102 comprises a transport portion 1162 that is retained in building 1148 rotatably around a rotation axis RA.

The rotation axis RA extends parallel to the motion path for the tracked vehicle defined by the travel path arrangement 1022, which motion path is defined in particular by the, preferably perpendicular, extension of the travel channels 1024, wherein the tracked vehicle contacts the travel path arrangement 1022 in the travel channels 1024 during travel.

Transport portion 1162 is directly adjacent to first pair 1158 and second pair 1160 of travel channels 1024, which are each embodiments of travel portions. Transport portion 1162 is preferably embodied as a plate, which is not explicitly depicted in FIG. 14 in the interest of clarity. Transport portion 1162 encompasses on a first side of transport portion 1162 a first pair 1164 of portions of travel channels 1024 which proceed in parallel, and encompasses a second pair 1166, arranged on a second side of transport portion 1162, of portions of travel channels 1024 which proceed in parallel, the first side of transport portion 1162 being arranged oppositely from the second side of transport portion 1162.

It is further possible also to consider each individual side of the transport portion 1162 together with the respective portions of travel channels 1024 and portions of the respective carrying arrangement 1023, 1025, each arranged on that side, as a single transport portion.

In a first idle position of transport portion 1162, first pair 1164 of portions of travel channels 1024 which proceed in parallel is aligned flush with the travel channels of first pair 1158 of travel channels 1024, and second pair 1166 of portions of travel channels 1024 which proceed in parallel is aligned flush with the travel channels of second pair 1160 of travel channels 1024. In a second idle position of transport portion 1162, first pair 1164 of portions of travel channels 1024 which proceed in parallel is aligned flush with the travel channels of second pair 1160 of travel channels 1024, and second pair 1166 of portions of travel channels 1024 which proceed in parallel is aligned flush with the travel channels of first pair 1158 of travel channels 1024.

In each of the first and the second idle position of transport portion 1162, this arrangement allows a tracked vehicle 1020 to travel from one pair from among first pair 1158 or second pair 1160 of travel channels 1024 onto the respective pair 1164, 1166 of portions of travel channels 1024 of transport portion 1162 which proceed in parallel. When transport portion 1162 is rotated from the first into its second idle position, tracked vehicle 1020 can thus leave transport portion 1162 and continue moving along the other pair from among first pair 1158 or second pair 1160 of travel channels.

As is evident from FIGS. 14a and 14c, vehicle system 1102 does not have a bottom turning point; in this embodiment, the travel channels of first pair 1158 of travel channels 1024 do not end in a transport portion. In the region shown in FIG. 14c, the travel channels of second pair 1160 of travel channels 1024 constitute a travel portion that is adjacent to a transport portion 1168. Transport portion 1168 is arranged in a recess 1170 of a turret arrangement 1172; turret arrangement 1172 can comprise a plurality of transport portions 1168, only some of which are labeled with reference characters. Except for the type of motion capability, transport portions 1168 are embodied substantially like transport portions 142, and an explicit description is dispensed with at this juncture. Recess 1170 can be embodied cylindrically. Transport portions 1168 can be arranged on a ring of turret arrangement 1172 for motion together.

The ring of turret arrangement 1172 can be rotated around a rotation axis RRA so that the individual transport portions 1168, preferably fastened thereon in stationary fashion, become displaced upon said rotation. Turret arrangement 1172 is preferably rotated around rotation axis RRA between defined positions in which a transport portion 1168 is aligned so that portions of travel channels 1024 which are arranged on it are aligned flush with travel channels 1024 of second pair 1160 of travel channels 1024.

The rotation axis RRA preferably extends parallel to the motion path for the tracked vehicle defined by the extension of the travel channels 1024, as explained above, and thus in particular parallel to the rotation axis RA. The rotation axis RRA or/and the rotation axis RA preferably extend perpendicularly.

A tracked vehicle 1020 can correspondingly travel via pair 1160 of travel channels onto one of transport portions 1168. A tracked vehicle 1020 can likewise travel from transport portion 1168 aligned with pair 1160 of travel channels onto pair 1160 of travel channels. Turret arrangement 1172 can be rotated between the defined positions. Tracked vehicles 1020 can thereby be parked in turret arrangement 1172, or parked tracked vehicles can be brought out from the turret arrangement onto travel path arrangement 1022. The individual transport portions 1168 each constitute offset receiving spaces.

Analogously to transport portion 140' of vehicle system 102, instead of turret arrangement 1172 (or on any floor of building 148 above the turret arrangement) a rotatable transport portion can be provided which performs the function of transport portion 1162 but at a bottom turning point of the paternoster lift-shaped motion path of the tracked vehicles.

In the exemplifying embodiment described here, travel path arrangement 1022 proceeds vertically and can be traveled on from two oppositely arranged sides. In general, travel path arrangements that can be traveled on from two oppositely arranged sides, i.e. “back to back,” can be aligned in any way, in particular horizontally.

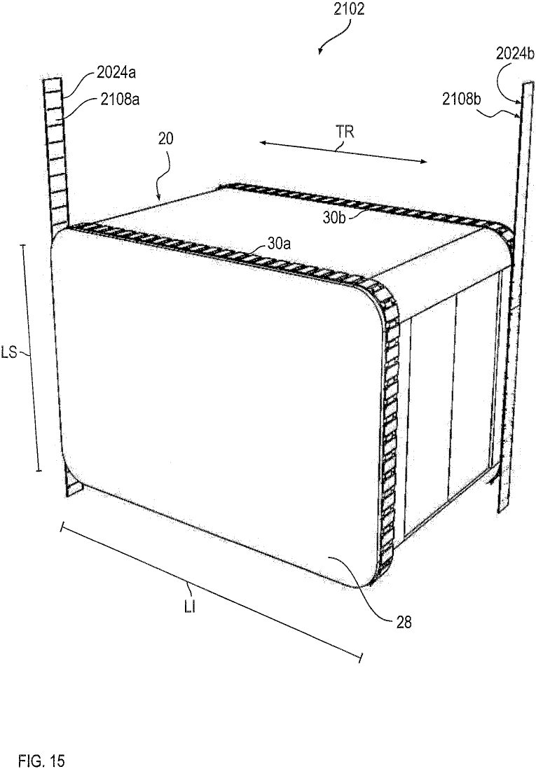

A further embodiment of vehicle system 2102 shown in FIG. 15 will be described below, reference being made only to the differences with respect to the embodiment of vehicle system 102 and tracked vehicles 20 used therein. Reference is made to the first embodiment for a description of the further elements, parts, and subassemblies; in the further embodiment, elements, parts, and subassemblies are labeled with a reference character incremented by 2000 as compared with those elements, parts, and subassemblies of the first embodiment to which they correspond. Details of the embodiments are in some cases omitted from the Figures, but the aspects of the first embodiment of vehicle system 102 can be used for the further embodiment of vehicle system 2102.

FIG. 15 shows vehicle system 2102, in which a tracked vehicle 20 that has already been described in the Application is used. Vehicle system 2102 comprises two travel channels 2024a, 2024b, which proceed parallel to one another and whose travel channel bottoms 2108a, 2108b also proceed parallel to one another. In a depth direction TR of the travel channel bottoms (the double arrow in FIG. 15 shows the depth direction of the two travel channels 2024a, 2024b), travel channel bottoms 2108a, 2108b are offset from one another, and the openings of travel channels 2024a, 2024b face in substantially opposite directions. Travel channel bottoms 2018a, 2108b are also offset from one another in a direction perpendicular to depth direction TR and perpendicular to a direction of extent of at least one of, preferably both, travel channels 2024a, 2024b. Tracked vehicle 20 has an extent LI parallel to depth direction TR and an extent LS parallel to the direction of extent of at least one of, preferably both, travel channels 2024a, 2024b, extent LS being less than extent LI. Travel channel 2024a is in contact with drive track 30a, and travel channel 2024b is in contact with drive track 30b, in a context of operation of vehicle system 2102 as intended; drive tracks 30a, 30b move counter-directionally. Such an arrangement decreases a tilting moment of tracked vehicle 20 relative to the travel path arrangement, encompassing travel channels 2024a and 2024b, of vehicle system 2102.

It is also possible, as shown in FIG. 4, to provide two oppositely located travel path arrangements 22a' and 22b' for tracked vehicle 20', each of which encompasses a pair of travel channels 24'. Travel path arrangements 22a' and 22b' are preferably embodied and arranged in mirror-image fashion with respect to a plane of symmetry orthogonal to the direction of the distance between travel path arrangements 22a' and 22b'.

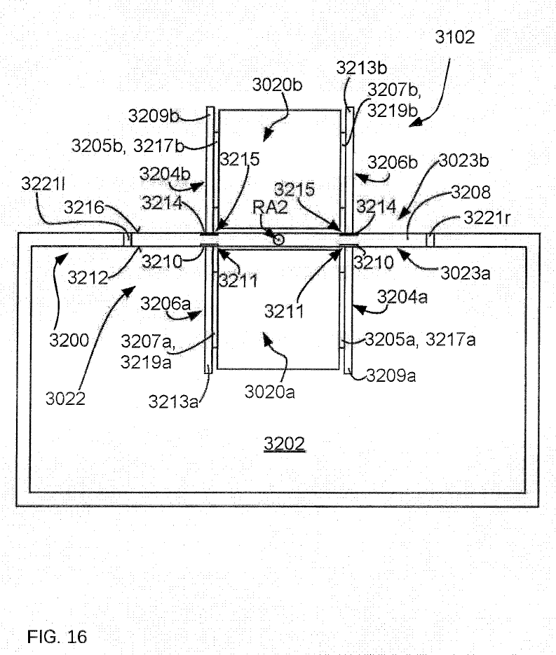

FIG. 16 schematically shows an embodiment of a vehicle system 3102 configured as an elevator system, comprising two tracked vehicles 3020a, 3020b, preferably each according to the invention, and a travel path arrangement 3022. The travel path arrangement 3022 is arranged on a wall 3200 of an elevator shaft 3202, the drawing surface of FIG. 16 extending perpendicularly to the motion path of the tracked vehicle 3020a. The travel path arrangement 3022 can include travel channels.

Each of the tracked vehicles 3020a, 3020b includes a first arrangement 3204a, 3204b including a first load subassembly 3205a, 3205b, a first drive track 3209a, 3209b, and a first linear motor, and a second arrangement 3206a, 3206b including a second load subassembly 3207a, 3207b, a second drive track 3213a, 3213b, and a second linear motor. The respective load subassemblies 3205a, 3205b, 3207a, 3207b are preferably attached to the load receiving space, in this case a cab, of the respective tracked vehicle 3020a, 3020b. The linear motors are not explicitly shown in FIG. 16 because they are hidden by the respective drive tracks and load subassemblies.

The first 3205a, 3205b or/and second 3207a, 3207b load subassemblies can each comprise an associated first 3217a, 3217b or second frame 3219a, 3219b, respectively, wherein the first load subassembly 3205a, 3205b can be formed by the first frame 3217a, 3217b or/and wherein the second load subassembly 3207a, 3207b can be formed by the second frame 3219a, 3219b. Preferably, the first 3205a, 3205b or/and second 3207a, 3207b load subassembly, or the frame forming this load subassembly, is bolted or/and welded or/and riveted or/and glued to the cab of the respective tracked vehicle 3020a, 3020b. On the first frame is 3217a, 3217b a stator of the first linear motor is arranged stationary with respect to the first frame 3217a, 3217b using screws or/and rivets or/and welds or/and an adhesive or/and on the second frame 3219a, 3219b a stator of the second linear motor is arranged stationary with respect to the second frame 3219a, 3219b using screws or/and rivets or/and welds or/and an adhesive.

The travel path arrangement 3022 is arranged in particular partially on a wall portion 3208 of the wall 3200, which travel path arrangement is arranged rotatably about a rotation axis RA2. The rotation axis RA2 extends preferably perpendicularly.

The portion of the travel path arrangement 3022 extending on the wall portion 3208 includes a first portion 3210 of its carrying arrangement and a first portion 3211 of its track supporting surface. The first portion 3210 of the carrying arrangement and the first portion 3211 of the track supporting surface are each disposed on a first side 3212 of the wall portion 3208, and thus each disposed on a first side of the travel path arrangement. The portion of the travel path arrangement 3022 extending on the wall portion 3208 further includes a second portion 3214 of its support assembly and a second portion 3215 of its track supporting surface. The second portion 3214 of the support assembly and the second portion 3215 of the track supporting surface are each disposed on a second side 3216 of the wall portion 3208 opposite the first side 3212, and thus each disposed on a second side of the travel path arrangement 3022 opposite the first side.

The wall portion 3208 with the above-described portions of the travel path arrangement 3022 arranged thereon at the first side 3212 form a first transport portion 3023a of the travel path arrangement, and the wall portion 3208 with the above-described portions of the travel path arrangement 3022 arranged thereon at the second side 3216 form a second transport portion 3023b of the travel path arrangement.

The rotation axis RA2 extends preferably perpendicular to the drawing plane, and thus parallel to the motion path of the tracked vehicle 3020a located in the elevator shaft 3202.

The transport portion 3023a is in an idle position and a transfer position, in which the tracked vehicle 3020a can drive onto this transport portion 3023a and can also leave it. Provided that the tracked vehicle 3020a remains in this position, the wall portion 3208 can be rotated about the rotation axis RA2, and with it the transport portions 3023a, 3023b can be rotationally displaced in such a way that the transport portion 3023a is transferred from a transfer position to a parked position and the transport portion 3023b is transferred from a parked position to a transfer position. Provided that no further tracked vehicle 3020b is arranged at the transport portion 3023b, the elevator shaft becomes free after this displacement and the position previously occupied by the tracked vehicle 3020a can be occupied by a further tracked vehicle, which is for example moving perpendicular to the drawing plane and which is not shown.

In FIG. 16, the transport portion 3023b with the tracked vehicle 3020b shown thereon is preferably in an idle position and a parked position in which the tracked vehicle 3020b can be loaded, unloaded or parked.

The wall portion 3208 described herein can form a transition of the vehicle system 3102 to the building surrounding the elevator shaft 3202, but can also form a transition from the elevator shaft 3202 to an approach position of a tracked vehicle at which a tracked vehicle can enter the vehicle shaft from the outside. At this entry, the tracked vehicle can drive onto the transport portion 3023b and can then enter the elevator shaft 3202 by rotation of the wall portion 3208 by 180° about the rotation axis RA2.

In particular, the wall portion 3208 described herein can provide a transition to the building 148 described in connection with FIG. 13, wherein the wall portion 3208 with transport portion 3023a or/and transport portion 3023b can be part of the travel path arrangement 22 of FIG. 13.

The wall portion 3208 is separated from the remaining portion of the wall 3200 by gaps, of which gaps 3221l, 3221r are shown in FIG. 16, to allow the rotation of the wall portion 3208 about the rotation axis RA2. A gap dimension of the gaps 3221l, 3221r is preferably selected in such a way that the wall portion 3208 can be displaced by a rotation by 180° or/and a by rotation by 360° about the rotation axis RA2 with a first tracked vehicle 3020a arranged as intended, in particular centrally, on the first transport portion 3023a or/and with a second tracked vehicle 3020b arranged as intended, in particular centrally, on the second transport portion 3023b.

With regard to the travel path arrangement, its parts, the interaction of the parts of the first or second arrangement, in particular for providing a drive as well as the adhesion on magnetizable surfaces or on travel path arrangements, reference is made to the description of the preceding embodiments, the features of which can also be used in the embodiment of FIG. 16.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-21. (canceled)

22. A tracked vehicle encompassing:
a load subassembly;
a drive track that is retained movably on the load subassembly in order to execute a motion along a circulation path of the drive track;
a linear motor, a stator of the linear motor being arranged in stationary fashion with respect to the load subassembly, and a rotor of the linear motor being arranged for motion together with the drive track, and/or the rotor being embodied in the drive track,
wherein the rotor comprises permanent magnets that are arranged in the drive track and are embodied for motion together with the drive track.

23. The tracked vehicle according to claim 22, wherein permanent-magnet arrangements have an alternatingly opposite polarization direction being arranged one behind another in the drive track along the circulation path, each permanent-magnet arrangement comprising at least one permanent magnet, permanent-magnet arrangements that are directly successive to one another along the circulation path and are arranged in the drive track preferably being arranged with an alternatingly opposite polarization direction.

24. The tracked vehicle according to claim 22, wherein:
the stator comprising, along at least a portion of the circulation path, stator windings arranged one behind another for generating a magnetic field upon energization of the stator windings; and
the tracked vehicle comprising a power converter that is electrically conductively connected to the stator windings.

25. The tracked vehicle according to claim 24, further encompassing an energy reservoir for supplying the power converter with electrical energy, the energy reservoir preferably being embodied separately from the power converter.

26. The tracked vehicle according to claim 24, further encompassing a current collector for supplying the power converter with electrical energy.

27. The tracked vehicle according to claim 22, wherein the drive track encompassing a neutralization strand on which an activatable neutralization magnet arrangement of the tracked vehicle is arranged; and
the neutralization magnet arrangement being configured to constitute, at the neutralization strand, a magnetic field that quantitatively weakens or neutralizes a magnetic field of at least one permanent magnet that is located in the neutralization strand.

28. The tracked vehicle according to claim 27, wherein:
the drive track encompassing one supporting surface contact strand and two deflection strands, each deflection strand directly adjoining the supporting surface contact strand along the circulation path; and
the neutralization strand encompassing a portion of the supporting surface contact strand directly adjacent to one of the deflection strands, and/or encompassing a portion of the drive track in a transition region between the supporting surface contact strand and a deflection strand, and/or encompassing a portion of the supporting surface contact strand or the entire supporting surface contact strand.

29. The tracked vehicle according to claim 22, wherein the tracked vehicle encompassing a plurality of drive tracks.

30. The tracked vehicle according to claim 22, wherein the drive track encompassing one supporting surface contact strand and two deflection strands, each deflection strand directly adjoining the supporting surface contact strand along the circulation path; and
the stator comprising stator windings, arranged one behind another along at least a portion of the circulation path, for generating a magnetic field upon energization of the stator windings, which are arranged along at least one of the deflection strands and/or along the supporting surface contact strand and/or along a further strand of the drive track which differs from the supporting surface contact strand and is arranged between the deflection strands, and/or are arranged along the entire circulation path.

31. A vehicle system encompassing:
a tracked vehicle; and
a travel path arrangement,
the tracked vehicle encompassing:
a load subassembly;
a drive track having permanent magnets embodied for motion together with the drive track,
the travel path arrangement comprising a track supporting surface that is configured to come into direct contact with the drive track, and
the travel path arrangement encompassing a magnetizable first carrying arrangement extends along the track supporting surface,
the permanent magnets and the first carrying arrangement being embodied in such a way that a mutually attractive magnetic force acts between the permanent magnets and the first carrying arrangement as a result of a magnetic interaction between the permanent magnets and the first carrying arrangement.

32. The vehicle system according to claim 31, wherein the magnitude of the magnetic force being greater at least than 50%, preferably 75%, particularly preferably 100%, highly preferably 150% or 250%, of a weight force of a permissible total weight of the tracked vehicle.

33. The vehicle system according to claim 31, wherein the travel path arrangement comprising a travel channel whose course defines, at least in portions, a motion path of the tracked vehicle along the track supporting surface.

34. The vehicle system according to claim 33, wherein the travel channel tapering in its depth direction in a direction toward the travel channel bottom.

35. The vehicle system according to claim 31, wherein the travel path arrangement comprising projections and/or depressions arranged on the track supporting surface, and the drive track comprising depressions and/or projections arranged on a supporting surface contact surface of the drive track, in such a way that upon direct contact between the track supporting surface and the supporting surface contact surface, a positive engagement is constituted which acts substantially parallel to a portion of the circulation path which is associated with the supporting surface contact surface.

36. The vehicle system according to claim 32, wherein:
the travel path arrangement encompassing:
a stationary travel portion that encompasses a portion of the track supporting surface and a portion of the first carrying arrangement;
a transport portion that comprises a further portion of the track supporting surface which is at least temporarily adjacent to the travel portion, and a further portion of the first carrying arrangement,
the further portion of the track supporting surface and the further portion of the first carrying arrangement being arranged in stationary fashion with reference to the transport portion, and the transport portion, together with the further portion of the first carrying arrangement and the further portion of the track supporting surface, being arranged movably with reference to the travel portion.

37. The vehicle system according to claim 36, wherein the transport portion, being configured, alone and/or with the tracked vehicle arranged thereon, to be offset translationally and/or rotationally, preferably to be displaced, by means of an offset device.

38. The vehicle system according to claim 36, further encompassing a receiving space, offset and/or offsettable with respect to the travel portion, which is embodied to receive a transport portion or encompasses a transport portion.

39. The vehicle system according to claim 32, wherein the travel path arrangement encompassing a second carrying arrangement that is arranged with an offset with respect to the first carrying arrangement.

40. The vehicle system according to claim 39, wherein the first carrying arrangement being arranged on a first side of the travel path arrangement, and the second carrying arrangement on a second side, located oppositely from the first side, of the travel path arrangement, or the first carrying arrangement and the second carrying arrangement being arranged on one common side of the travel path arrangement.

41. Use of a vehicle system according to claim 32 to transport loads in and/or on a building, the travel path arrangement being arranged on and/or in a building, and the tracked vehicle encompassing an elevator cab and/or a load receiving arrangement.

42. The use according to claim 41, the vehicle system further encompassing a plurality of tracked vehicles that are moved simultaneously along a common motion path leading along the track supporting surface, in particular the motion path being embodied continuously, and preferably a distance along the motion path between two of the tracked vehicles being varied.
